(19) United States
(12) Patent Application Publication
(10) Pub. No.: US 2025/0373322 A1
(43) Pub. Date: Dec. 4, 2025

(54) PROVISIONING DATA TO SATELLITES VIA GATEWAYS IN FIFTH GENERATION COMMUNICATION NETWORK

(71) Applicant: WILDSTAR, LLC, Beverly, MA (US)

(72) Inventors: Volkan Sevindik, Parker, CO (US); Anish Sharma, Mckinney, TX (US)

(73) Assignee: WILDSTAR, LLC, Beverly, MA (US)

(21) Appl. No.: 19/252,492

(22) Filed: Jun. 27, 2025

Related U.S. Application Data
(60) Provisional application No. 63/654,522, filed on May 31, 2024.

(51) Int. Cl. H04B 7/185; H04B 7/195

(52) U.S. Cl. CPC H04B 7/1851; H04B 7/1855; H04B 7/18593; H04B 7/195

(57) ABSTRACT

The disclosed technology is generally directed to a method for provisioning data in a fifth generation (5G) communication network. In one example of the technology, the method may include storing user data profiles associated with the 5G communication network in a centralized communication server, determining a satellite that provisions 5G communication network over a region on the Earth during a time interval, and identifying a set of user equipment (UE) in the region. The method may include retrieving a set of user data profiles corresponding to the set of UE from the centralized communication server and determining a gateway that is in communication with the satellite. The method may include provisioning the set of user data profiles from the centralized communication server to the satellite via the gateway before the satellite reaches the region, thereby enabling the satellite to provision the 5G communication network to the set of UE.

### CROSS REFERENCE TO RELATED APPLICATIONS

This application claims the benefit of U.S. Provisional Application Ser. No. 63/654,522, filed on May 31, 2024, the disclosure of which is incorporated herein by reference.

### TECHNICAL FIELD

This disclosure is directed to satellite communication, and more particularly, to provisioning data to satellites via gateways in fifth generation (5G) communication network.

### BACKGROUND

Satellite communication in fifth generation (5G) involves the use of orbiting satellites to relay signals between ground-based 5G infrastructure and user devices. These satellites act as intermediaries, facilitating communication across large geographical areas. When a user initiates a communication, the signal is transmitted from a user equipment of the user to a ground station, which then relays the signal to the satellite. The satellite receives the signal, processes the signal, and retransmits the processed signal to another ground station near the intended recipient. Finally, the ground station relays the signal to a recipient's user equipment. Despite its advantages, satellite communication faces challenges such as propagation delay, power requirements, and aging effects, which need to be addressed for seamless integration with 5G networks.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, an exemplary embodiment of the present disclosure may provide a method for provisioning data in a fifth generation (5G) communication network. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features.

The method may include storing a plurality of user data profiles associated with the 5G communication network in a centralized communication server, determining at least one satellite of a constellation of satellites that provisions 5G communication network over a first region on the Earth during a first time interval, and identifying a first set of user equipment in the first region to be provisioned the 5G communication network by the at least one satellite. The method may further include retrieving a first set of user data profiles corresponding to the first set of user equipment from the centralized communication server and determining at least a first gateway of a plurality of gateways that is in communication with the at least one satellite. Each gateway is communicatively coupled with the centralized communication server. The method may furthermore include provisioning the first set of user data profiles from the centralized communication server to the at least one satellite via the first gateway before the at least one satellite reaches the first region, thereby enabling the at least one satellite to provision the 5G communication network to the first set of user equipment based on the first set of user data profiles.

Implementations may include one or more of the following features. In some implementations, the method may further include determining a movement of the at least one satellite such that the at least one satellite provisions 5G communication network over a second region on the Earth during a second time interval. The second region corresponds to a coverage area of the at least one satellite during the second time interval. The second region may comprise one of a country, a collection of countries, a portion of a country, a portion of oceans, and any combination thereof based on a coverage plan. The method may further include identifying a second set of user equipment in the second region to be provisioned the 5G communication network by the at least one satellite and retrieving a second set of user data profiles corresponding to the second set of user equipment from the centralized communication server.

In some implementations, the method may further include, provisioning the second set of user data profiles from the centralized communication server to the at least one satellite via the first gateway before the at least one satellite reaches the second region, thereby enabling the at least one satellite to provision the 5G communication network to the second set of user equipment based on the second set of user data profiles.

In some implementations, the method may further include, determining whether communication between the first gateway and the at least one satellite is terminated, determining at least a second gateway of a plurality of gateways that is in communication with the at least one satellite when the communication between the first gateway and the at least one satellite is terminated, and provisioning the second set of user data profiles from the centralized communication server to the at least one satellite via the second gateway before the at least one satellite reaches the second region, thereby enabling the at least one satellite to provision the 5G communication network to the second set of user equipment based on the second set of user data profiles.

In some implementations, the method may further include, determining a set of gateways from the plurality of gateways coupled between the centralized communication server and the first gateway when the first gateway is coupled to the centralized communication server by way of the set of gateways. The provisioning of the first set of user data profiles from the centralized communication server to the at least one satellite via the first gateway comprises routing the first set of user data profiles from the centralized communication server to the first gateway via the set of gateways.

In some implementations, each user data profile comprises at least one of subscription data and policy data associated with a corresponding user equipment and indicates a type of service to be provisioned to the corresponding user equipment.

In some implementations, the first set of user data profiles is provisioned to the at least one satellite via a routing plane of the centralized communication server and a routing plane of the first gateway.

In some implementations, each satellite of the constellation of satellites is configured to implement a 5G core network, and a 5G base station that communicates with at least one user equipment of the plurality of user equipment. Each gateway is configured to: route and forward the communications between the centralized communication server and the 5G core network of each satellite to facilitate the communications between the 5G base stations with the plurality of user equipment.

In some implementations, the method may further include, the first region corresponds to a coverage area of the at least one satellite during the first time interval. The first region may comprise one of a country, a collection of countries, a portion of a country, a portion of oceans, and any combination thereof based on a coverage plan.

In some implementations, the method may further include utilizing the first set of user data profiles for at least one of registration management, authentication, authorization, session management, charging, billing, service access, and mobility management associated with the 5G communication network for the first set of user equipment.

In some implementations, the method may further include storing a first set of user information associated with the first set of user data profiles in the centralized communication server by a previous satellite of the constellation of satellites as the previous satellite provisions the 5G communication network to the first set of user equipment during a previous time interval and provisioning the first set of user information from the centralized communication server to the at least one satellite via the at least one gateway before the at least one satellite reaches the first region. Each user information of the first set of user information comprises authentication information associated with the user equipment, registration information generated at completion of registration of a user equipment with the previous satellite, session setup information generated during session establishment procedures between the user equipment and the previous satellite, and control context and user plane context required to continue a communication session of the user equipment on the 5G communication network provisioned by the previous satellite, and charging data associated with the communication session.

In some implementations, the method may further include generating a second set of user information associated with the first set of user data profiles as the at least one satellite provisions the 5G communication network to the first set of user equipment during the first time interval, and provisioning the second set of user information from the at least one satellite to the centralized communication server via at least the first gateway.

In some implementations, the method may further include provisioning the second set of user information from the at least one satellite to a next satellite via at least the first gateway and the centralized communication server before the next satellite reaches the first region. The provisioning of the second set of user information from the at least one satellite to the next satellite ensures continuity in the communication session of the user equipment on the 5G communication network during handover of coverage from the at least one satellite to the next satellite.

In some implementations, the 5G communication network corresponds to a low earth orbit (LEO) satellite based 5G communication network.

In another aspect, an exemplary embodiment of the present disclosure may provide a system for provisioning data in a 5G communication network. The system includes at least one hardware-based processor and memory. The memory comprises processor-executable instructions encoded on a non-transient processor-readable media. The processor-executable instructions, when executed by the at least one hardware-based processor, configure the system to store a plurality of user data profiles associated with the 5G communication network in a centralized communication server, determine at least one satellite of a constellation of satellites that provisions 5G communication network over a first region on the Earth during a first time interval, and identify a first set of user equipment in the first region to be provisioned the 5G communication network by the at least one satellite. The processor-executable instructions, when executed by the at least one hardware-based processor, further configure the system to retrieve a first set of user data profiles corresponding to the first set of user equipment from the centralized communication server and determine at least a first gateway of a plurality of gateways that is in communication with the at least one satellite. Each gateway is communicatively coupled with the centralized communication server. The processor-executable instructions, when executed by the at least one hardware-based processor, further configure the system to provision the first set of user data profiles from the centralized communication server to the at least one satellite via the first gateway before the at least one satellite reaches the first region, thereby enabling the at least one satellite to provision the 5G communication network to the first set of user equipment based on the first set of user data profiles.

In yet another aspect, an exemplary embodiment of the present disclosure may provide a non-transitory computer-readable medium storing a set of instructions for provisioning data in a 5G communication network. The set of instructions comprising one or more instructions that, when executed by one or more processors of a device, cause the device to store a plurality of user data profiles associated with the 5G communication network in a centralized communication server, determine at least one satellite of a constellation of satellites that provisions 5G communication network over a first region on the Earth during a first time interval, and identify a first set of user equipment in the first region to be provisioned the 5G communication network by the at least one satellite. The one or more instructions that, when executed by the one or more processors of a device, further cause the device to retrieve a first set of user data profiles corresponding to the first set of user equipment from the centralized communication server and determine at least a first gateway of a plurality of gateways that is in communication with the at least one satellite. Each gateway is communicatively coupled with the centralized communication server. The one or more instructions that, when executed by the one or more processors of a device, further cause the device to provision the first set of user data profiles from the centralized communication server to the at least one satellite via the first gateway before the at least one satellite reaches the first region, thereby enabling the at least one satellite to provision the 5G communication network to the first set of user equipment based on the first set of user data profiles.

Further aspects, features, applications and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE SEVERAL VIEWS OF THE DRAWINGS

For a better understanding of the present disclosure, non-limiting and non-exhaustive examples of the present disclosure are described with reference to the following drawings, in which:

FIG. 1 is a simplified diagram illustrating a system environment for fifth generation (5G) communication using satellites in which aspects of the technology may be employed;

FIG. 2 is a block diagram of a centralized communication server of the system environment of FIG. 1 in which aspects of the technology may be employed;

FIG. 3 is a block diagram of a gateway of the system environment of FIG. 1 according to aspects of the disclosed technology;

FIG. 4 is a block diagram illustrating a satellite of the system environment of FIG. 1 according to aspects of the disclosed technology;

FIGS. 5 and 6 are block diagrams illustrating example 5G system architectures according to aspects of the disclosed technology;

FIG. 7 is a block diagram illustrating data flows through the gateway and the satellite according to aspects of the disclosed technology;

FIGS. 8A and 8B are block diagrams illustrating provisioning of data in a 5G communication network according to aspects of the disclosed technology;

FIGS. 9A-9C, collectively, represent a flow chart illustrating one example of a method of provisioning data provisioning data in the 5G communication network according to aspects of the disclosed technology;

FIGS. 10A and 10B, collectively, represent a flow chart illustrating another example of a method of provisioning data provisioning data in the 5G communication network according to aspects of the disclosed technology; and

FIG. 11 is a diagram illustrating one example of a computing device in which aspects of the technology may be practiced.

In the drawings, similar reference numerals refer to similar parts throughout the drawings unless otherwise specified. These drawings are not necessarily drawn to scale.

### DETAILED DESCRIPTION

Technologies are provided for providing fifth generation (5G) communication network to multiple user equipment (UE) based on satellites which include a 5G Core Network and a 5G Base station. Technologies are also provided for provisioning user profiles and context information from ground stations to the satellite and transferring the user profiles and the context information between satellites. The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

Implementations of the techniques described herein may include hardware, a method or process, or a non-transitory computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features. Prior to describing exemplary embodiments that incorporate the features of the present disclosure, a discussion of security concepts that are appliable to the exemplary embodiments will be provided.

A satellite communications system is a non-terrestrial network (NTN) including ground stations and satellites (e.g., non-geostationary satellites) such that each satellite includes a base station that is configured to communicate with multiple user equipment (UE) in a given coverage area based on a 5G communication network. To communicate with the multiple UE, the satellites may act as intermediaries, facilitating 5G communication network across large geographic areas by relaying signals between ground stations far away from each other. In this regard, the ground base station serves or acts as a network node.

Technical Problem with Conventional Satellite Communication Systems

In conventional satellite communication systems, since the satellite acts as an intermediaries to relay the signals received from ground stations to other ground station at far away distances, the satellite communication faces challenges such as propagation delay, power requirements, and aging effects, which need to be addressed for seamless integration with 5G networks. For example, core network may be configured in the satellite along with the base station such that the satellite may act as a network node and provision the 5G communications network directly to the multiple UE on ground without the need to relaying signals to any ground station. However, non-geostationary satellites may orbit the Earth and continuously move from one position to another and thus servicing different regions on the Earth at different time intervals. Additionally, low earth orbit (LEO) communication satellites revolve around the Earth (or other body) at high speeds. Each LEO communication satellite transmits a beam that covers a specific coverage area or circular footprint (e.g., on the Earth's surface). The coverage area of a beam in Low Earth Orbit (LEO) can vary depending on several factors, including the satellite's altitude, the frequency it operates at, and the antenna design. To explain further, the coverage area can vary from hundreds to over tens of thousands square kilometers (km²). The altitude of an LEO satellite could range from about 180 kilometers to 2,000 kilometers above the Earth's surface. The higher the altitude, the larger the coverage area, but also the higher the latency. The number of cells within the coverage area of a LEO communication satellite depends on the satellite's design and the specific purpose of the satellite. In a simple scenario, a single satellite can have one beam covering its entire footprint, but in more advanced systems, a single satellite can have multiple spot beams for more focused coverage, each covering a portion of the satellite's coverage area, which may also be referred to as a cell. The radius of each cell within the satellite's coverage area depends on the satellite's altitude, frequency band, and the antenna design. Depending on the implementation, the cell radius could range from ten or less kilometers to over a hundred kilometers.

As such, a given base station mounted on a satellite has a relatively short time window of setting up a communication link with a ground-based UE (e.g., terminal or device). Thus, it is desirable to provision associated user data to the satellite which is required for provisioning the 5G communications network services to the corresponding UE of the users before the satellite may reach at a particular position to provide 5G communications network services in a particular region.

To circumvent this problem, one approach is to provision associated user data for all the UE connected to the 5G network to all the satellites in the constellation of satellites. However, a number of resources on the satellites may be limited due to various restrictions on size, power, and cost of the satellites. Thus, the method of provisioning associated user data to the satellites or between the satellites should be improved for seamless integration of 5G communication and improve efficiency, connectivity, and communication capability using satellites.

In accordance with the disclosed embodiments, a method is provided for provisioning data to the satellites for facilitating 5G communications network to the UE in different regions while the satellites are orbiting around the Earth. Further, in accordance with the disclosed embodiments, a method is provided for provisioning data to between satellites via inter satellite links (ISLs) for facilitating 5G communications network to the UE in different regions while the satellites are orbiting around the Earth.

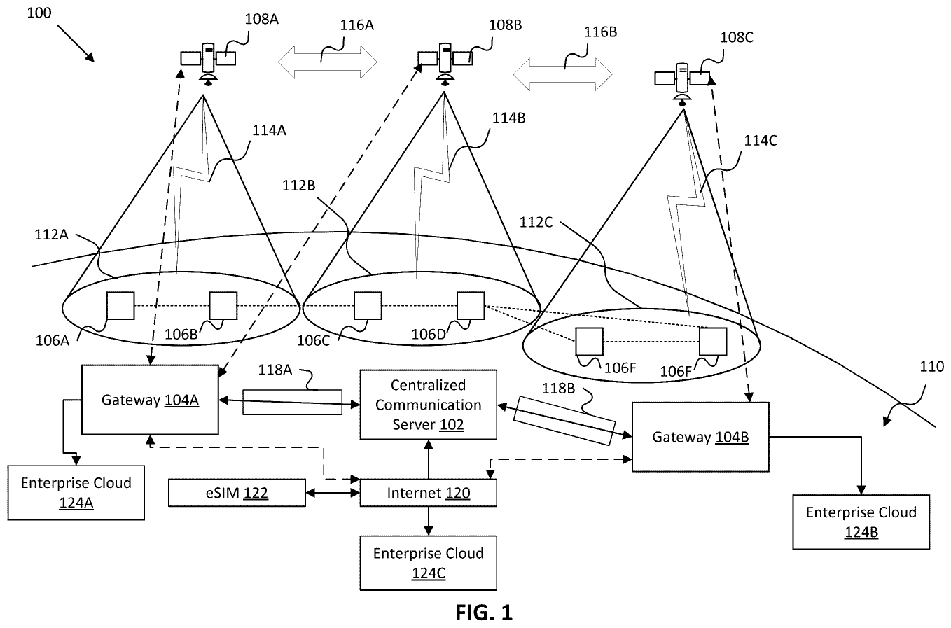

Having given this description of 5G communications based on satellites and provisioning of data to the satellites and between satellites that can be applied within the context of the present disclosure, technologies will now be described with reference to FIGS. 1-11 for 5G communication based on satellites.

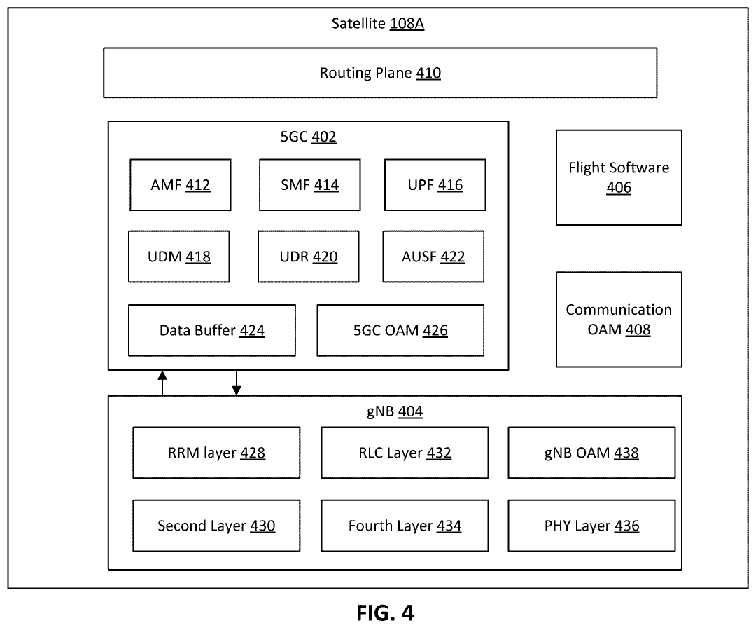

FIG. 1 is a simplified diagram illustrating a system environment 100 for 5G communication using satellites in which aspects of the technology may be employed. The system environment 100 includes a centralized communication server 102, multiple gateways 104, multiple user equipment (UE) 106 that are in communication with each other, a constellation of satellites 108 that are in communication with one or more of the UE 106. The constellation of satellites 108 includes a group of artificial satellites that are positioned in a number of different orbits around the Earth 110 to provide specific services or coverage. For instance, the satellites 108 may work together to offer communication, navigation, or remote sensing services to a wide geographic area on Earth. The constellation of satellites 108 may include any number of satellites to ensure global coverage and to provide redundancy in case of failure. In one embodiment, the satellites 108 may make up a 5G Non-Terrestrial Network, such as a Low Earth Orbit (LEO) constellation, and each satellite 108 is configured to implement a 5G core network (shown later in FIG. 4) and a base station (shown later in FIG. 4) that act or serve as a network node of the non-terrestrial network. The base station communicates with at least one UE of the plurality of UE 106. The gateways 104 may make up a communicative network and each satellite may be communicatively coupled to at least one of the gateways 104. In some cases, the system environment 100 may support enhanced broadband communications, ultra-reliable (e.g., mission critical) communications, low latency communications, or communications with low-cost and low-complexity devices. It should be appreciated that such satellite constellations can be arranged in different configurations, including low Earth orbit (LEO), medium Earth orbit (MEO), or geostationary orbit (GEO), depending on the intended application and the desired level of coverage and service.

Each of the satellites 108 is an artificial object placed in orbit around a celestial body, often referring to Earth 110. Each satellite typically includes various components such as a communication or scientific payload, power systems (such as solar panels), propulsion for orbit adjustments, and communication equipment to transmit and receive data to and from Earth 110. Each satellite, e.g., the satellite 108A, may include a 5G core network and a base station that may wirelessly communicate with UEs 106 via one or more antennas and provide 5G communication network services to the UEs 106 directly. The 5G core network of the satellites 108 may be referred to as a central component of a 5G network that may establish reliable, secure connectivity for end users and provides access to services. The 5G core network may be configured to perform functions including connectivity management, authentication, subscriber data management, and policy management. The base stations of the satellites 108 may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The base stations of the satellites 108 may be of different types (e.g., macro or small cell base stations). The UEs 106 described herein may be able to communicate with various types of base stations and network equipment including macro eNBs, small cell eNBs, gNBs, relay base stations, and the like.

Each satellite, for example satellite 108A, may be associated with a particular geographic coverage area, for example, geographic coverage area 112A in which communications with various UEs, such as the UEs 106A and 106B is supported. For sake of simplicity, FIG. 1 shows a simplified representation that includes three geographic coverage areas 112, which may be referred to herein as a first geographic coverage area 112A, a second geographic coverage area 112B, and a third geographic coverage area 112C; however, it should be appreciated that each satellite 108 includes an associated geographic coverage area. Each satellite may provide communication coverage for a respective geographic coverage area via communication links 114, and communication links 114 between a base station of satellite 108 and a UE 106 may utilize one or more carriers. The communication links 114 may include upstream transmissions from the UE 106 to the base station of satellite 108, or downstream transmissions from the base station of satellite 108 to the UE 106. Downstream transmissions may also be called downlink or forward link transmissions while upstream transmissions may also be called uplink or reverse link transmissions.

Although not shown in FIG. 1, each geographic coverage area 112 of a satellite 108 may be divided into sectors (not shown) each making up a portion of the geographic coverage area 112, and each sector may be associated with a cell. For example, each satellite may provide communication coverage for a macro cell, a small cell, a hot spot, or other types of cells, or various combinations thereof. In some examples, the satellites may be non-stationary and therefore provide communication coverage for a moving geographic coverage area 112. In some examples, different geographic coverage areas 112 associated with different technologies may overlap, and the overlapping geographic coverage areas 112 associated with different technologies may be supported by the same satellite or by different satellites. The system environment 100 may include, for example, a heterogeneous 5G network in which different types of satellites provide coverage for various geographic coverage areas 112.

The term “cell” refers to a logical communication entity used for communication with a base station (e.g., over a carrier) or a satellite beam, and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 112 (e.g., a sector) over which the logical entity operates.

Each satellite, for example satellite 108A, may be communicatively coupled with other satellites, for example satellite 108B, via intersatellite links 116, for example intersatellite link 116A, which allow satellites 108 in a constellation to link to one another and relay data in space. For sake of simplicity, FIG. 1 shows a simplified representation that includes two intersatellite links, which may be referred to herein as a first intersatellite link 116A and a second intersatellite link 116B; however, it should be appreciated that any two satellites may be communicatively coupled via an associated intersatellite link. Each satellite may provide or receive data to or from other satellites via inter satellite links 116.

Each of the gateways 104 on Earth 110 may wirelessly communicate with satellites 108 via one or more antennas (not shown). The gateways 104 may be configured to route and forward the data associated with the 5G communications between the 5G core network of the satellites 108 and the centralized communication server 102 to facilitate the 5G communications between the 5G base station with the at least one UE 106. In one embodiment, each gateway 104 may be communicatively coupled to the centralized communication server 102 by way of a transport medium 118 to route the data to and from the satellites 108. For example, the gateways 104A and 104B may be communicatively coupled to the centralized communication server 102 by way of the transport mediums 118A and 118B, respectively. Further, each gateway may be coupled to one or more gateways and may be configured to route data to or from the centralized communication server 102 directly or by way of one or more gateways between the respective gateway and the centralized communication server 102.

Each gateway 104, such as the gateway 104A, may be communicatively coupled to one or more of the satellites 108 when the one or more of the satellites 108 are within the communication range of the respective gateway 104. For sake of simplicity, FIG. 1 shows a simplified representation that includes two gateways 104, which may be referred to herein as a first gateway 104A and a second gateways 104B; such that the first gateway 104A is communicatively coupled to the first and second satellites 108A and 108B and the second gateway 104B is communicatively coupled to the third satellite 108C.

The UEs 106 may be deployed at different locations in a geographic coverage area 112 that includes, for example, a forest, an agricultural land, or the like. In one embodiment, for example, the UEs 106 are positioned at the different locations in certain geographic area to provide sensor coverage over part of or substantially all of the area. The UEs 106 may also be referred to as a mobile device, a wireless device, a remote device, a handheld device, or a subscriber device, or some other suitable terminology, where the “device” may also be referred to as a unit, a station, a terminal, or a client. The UE 106 may also be a personal electronic device such as a cellular phone, a personal digital assistant (PDA), a tablet computer, a laptop computer, or a personal computer. In some examples, the UE 106 may also refer to a wireless local loop (WLL) station, an Internet of Things (IoT) device, an Internet of Everything (IoE) device, or an MTC device, or the like, which may be implemented in various articles such as appliances, vehicles, meters, or the like.

In an embodiment, some or all of the UEs 106 may be implemented as MTC or IoT devices, which may be low cost or low complexity devices, and may provide for automated communication between machines (e.g., via Machine-to-Machine (M2M) communication). M2M communication or MTC may refer to data communication technologies that allow devices to communicate with one another or a base station of a satellite without human intervention. In some examples, M2M communication or MTC may include communications from devices that integrate sensors or meters to measure or capture information and relay that information to a central server or application program that can make use of the information or present the information to humans interacting with the program or application. The UEs 106 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The UEs 106 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for the UEs 106 include entering a power saving “deep sleep” mode when not engaging in active communications, or operating over a limited bandwidth (e.g., according to narrowband communications). In some cases, the UEs 106 may be designed to support critical functions (e.g., mission critical functions), and the system environment 100 may be configured to provide ultra-reliable communications for these functions.

In some embodiments, a UE, such as the UE 106A may also be able to communicate directly with other UEs, such as the UE 106B (e.g., using a peer-to-peer (P2P) or device-to-device (D2D) protocol). One or more of a group of UEs 106 utilizing D2D communications may be within the geographic coverage area 112 of a satellite, such as the geographic coverage area 112A of the satellite 108A. Other UEs 106 in such a group may be outside the geographic coverage area 112A of the satellite 108A or be otherwise unable to receive transmissions from the satellite 108A. In some cases, groups of UEs 106 communicating via D2D communications may utilize a one-to-many (1: M) system in which each UE 106 transmits to every other UE 106 in the group. In some cases, a base station facilitates the scheduling of resources for D2D communications. In other cases, D2D communications are carried out between UEs 106 without the involvement of a base station.

In some embodiments, the UEs 106 and the satellites 108 that make up the constellation are designed so that they are capable of non-line-of-sight (NLOS) communications with one another. When communication devices, such as the UEs 106 and based stations implemented at satellites 108, are capable of NLOS communication, the device can establish communication links 114 even when there are obstacles or obstructions between the transmitter and the receiver. In traditional line-of-sight communication, a clear and unobstructed path is needed between the transmitting and receiving antennas for reliable signal transmission. By contrast, NLOS communication allows signals to propagate and reach the receiver even if there are buildings, trees, terrain features, or other obstacles in the way. NLOS communication is particularly important, for example, in urban environments, dense foliage, indoor settings, and situations where direct line-of-sight paths are blocked.

The system environment 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 106 located indoors or under some obstruction or blockage. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

The system environment 100 may further operate in a super high frequency (SHF) region using frequency bands from 3 GHz to 30 GHZ, also known as the centimeter band. The SHF region includes bands such as the 5 GHz industrial, scientific, and medical (ISM) bands, which may be used opportunistically by devices that can tolerate interference from other users.

The system environment 100 may further operate in an extremely high frequency (EHF) region of the spectrum (e.g., from 30 GHz to 300 GHz), also known as the millimeter band. In some examples, the system environment 100 may support millimeter wave (mmW) communications between UEs 106 and base stations of satellites 108, and EHF antennas of the respective devices may be even smaller and more closely spaced than UHF antennas. In some cases, this may facilitate use of antenna arrays within a UE 106. However, the propagation of EHF transmissions may be subject to even greater atmospheric attenuation and shorter range than SHF or UHF transmissions. Techniques disclosed may be employed across transmissions that use one or more different frequency regions, and designated use of bands across these frequency regions may differ by country or regulating body.

In some cases, the system environment 100 may utilize both licensed and unlicensed radio frequency spectrum bands. For example, the system environment 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations of satellites 108 and UEs 106 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downstream transmissions, upstream transmissions, peer-to-peer transmissions, or a combination of these. Duplexing in unlicensed spectrum may be based on frequency division duplexing (FDD), time division duplexing (TDD), or a combination of both.

In some examples, the satellites 108 and/or UEs 106 may be equipped with multiple antennas, which may be used to employ techniques such as transmit diversity, receive diversity, multiple-input multiple-output (MIMO) communications, or beamforming. For example, the system environment 100 may utilize a transmission scheme between a transmitting device (e.g., a satellite 108 or a UE 106) and a receiving device (e.g., a UE 106 or a satellite 108), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

The system environment 100 may further include Internet 120, embedded subscriber identity module (eSIM) 122, and multiple enterprise clouds 124. The Internet 120 may be coupled with the gateways 104 and the centralized communication server 102. In one embodiment, the gateways 104 may be configured to write the data which is received by the gateways 104 from the satellites 108 directly over the Internet 120 or directly over the enterprise clouds 124A and 124B for collection and processing of data by associated enterprises or organizations. For example, the gateway 104A may be configured to directly send the data received from the satellites 108A and 108B to the enterprise cloud 124A and the gateway 104B may be configured to directly send the data received from the satellite 108C to the enterprise cloud 124B. In another embodiment, the gateways 104 may be configured to write the data which is received by the gateways 104 from the satellites 108 over the enterprise cloud 124C via the Internet 120 for collection and processing of data by associated enterprises or organizations. For example, the gateways 104A and 104B may be configured to send the data received from the satellites 108A-108C to the enterprise cloud 124C via the Internet 120. In one embodiment, the enterprise clouds 124A-124C may employ at least one of access stratum (AS) and application function (AF) features associated with the 5G communication network.

In one embodiment, at least one of the centralized communication server 102 and the gateways 104 may be communicatively coupled to the eSIM 122 by way of the Internet 120. The eSIM 122 may be a programmable SIM card that may be remotely provisioned. The eSIM 122 may employ subscription management data preparation (SM-DP) and subscription management secure routing (SM-SR) functions associated with the 5G communication network. The SM-DP function may be configured to prepare and store M2M eSIM profiles and the SM-SR function may be configured to establish a secure channel and interact with an embedded universal integrated circuit card (eUICC).

### Centralized Communication Server

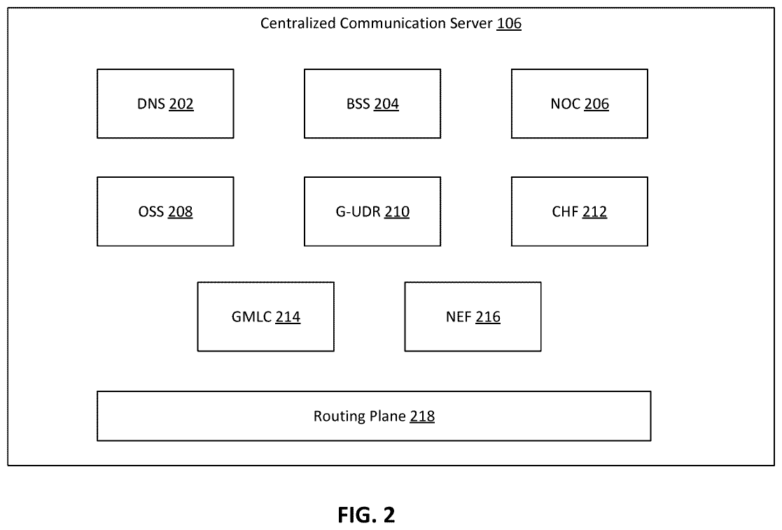

FIG. 2 is a block diagram of the centralized communication server 102 of the system environment 100 according to aspects of the disclosed technology. The centralized communication server 102 may be configured to control the 5G communications. The centralized communication server 102 may be further configured to exchange information associated with the 5G communications with each satellite of the constellation of satellites and at least one satellite of the constellation of satellites is further configured to exchange the information associated with the 5G communications with at least one another satellite. In one embodiment, the information associated with the 5G communication corresponds to at least one of user data profiles, user context information, information associated with initiation of connection with satellites, information associated with resuming the connection, information associated with restarting the connection, and information associated with tearing down the connection.

In one embodiment, the centralized communication server 102 may include a first set of 5G components from a plurality of 5G components. The plurality of 5G components may include at least an access and mobility management function (AMF), a session management function (SMF), a user plane function (UPF), a unified data management (UDM), a unified data repository (UDR), an authentication server function (AUSF), a ground UDR (G-UDR), a charging function (CHF), a policy control function (PCF), and a network exposure function (NEF). In an exemplary embodiment, the first set of 5G components may include the G-UDR, the CHF, the PCF, and the NEF.

As shown in FIG. 2, the centralized communication server 102 may include a domain naming system (DNS) 202, a business support system (BSS) 204, a network operations center (NOC) 206, an operations support system (OSS) 208, the G-UDR 210, the CHF 212, a gateway mobile location center (GMLC) 214, and the NEF 216, and a routing plane 218. In some exemplary embodiments, the centralized communication server 102 may further include the PCF, a switching plane, a data transport plane, and a security plane.

The DNS 202 may translate domain names (e.g., “www.example.com”) into internet protocol (IP) addresses. The DNS 202 may ensure low latency for services by quickly resolving domain names to IP addresses. The BSS 204 may manage business-related functions in a telecom network, including product management, order handling, billing, and customer services. The NOC 206 is a centralized hub where networks may be monitored and managed continuously to ensure continuous network connectivity, identify issues, and optimize network performance. The OSS 208 may manage network operations, including coordination of customers, services, resources, and activities. The OSS 208 may assist in designing, building, operating, and maintaining communication networks. The G-UDR 210 may be a 5G database that stores subscriber data, subscriber identity module (SIM) identities, and network service configurations and may serve as a centralized repository for subscription data, policy data, sessions, and application states. The G-UDR 210 supports APIs for other network functions like UDM, PCF, and NEF. The CHF 212 may handle charging and billing in 5G networks to ensure accurate charging for services, including data usage, voice calls, and other transactions. The GMLC 214 may provide location information for mobile devices during emergency services or location-based services. The NEF 216 may expose network capabilities and services to external applications and enable third-party applications to access network functions securely. The PCF manages policy enforcement and quality of service (QOS).

Further, the routing plane 218 may handle data routing and forwarding of the data associated with the 5G communications between the centralized communication server 102 and the gateways 104, the switching plane may ensure efficient data switching, the data transport plane may handle data transmission, and the security plane may ensure network security and protection against threats.

### Gateway

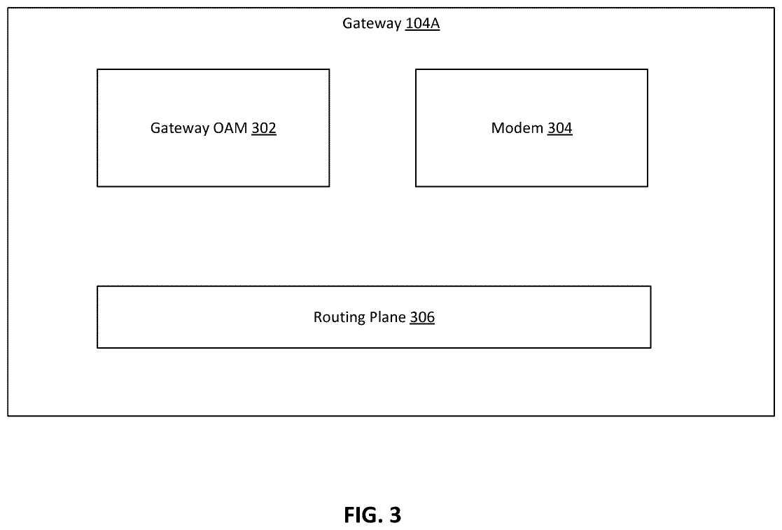

FIG. 3 is a block diagram of the gateway 104A of the system environment 100 according to aspects of the disclosed technology. The multiple gateways 104 on the Earth 110 may be communicatively coupled to the centralized communication server 102. Each gateway, such as the gateway 104A is configured to route and forward the 5G communications between the centralized communication server 102 and the 5G core network of each satellite 108 to facilitate the 5G communications between the 5G base station with the at least one UE 106.

As shown in FIG. 3, each gateway, such as the gateway 104A, may include a gateway operations and management agent (OAM) 302, a modem 304, and a routing plane 306. The gateway OAM 302 may be configured to connect space-based communication to terrestrial networks, handle communication with satellites 108, such as the satellites 108A and 108B, and manage ground-based operations associated with 5G communication. The modem 304 may be configured to transform an input bitstream (digital data) to a radio signal suitable for transmission through space and transform a radio signal received from space to an input bitstream (digital data). The routing plane 306 may handle data routing and forwarding between the centralized communication server 102 and the satellites 108 and within the gateways 104.

Further, in one embodiment, each gateway 104 may include a second set of 5G components from the plurality of 5G components. In an exemplary embodiment, the second set of 5G components may include the CHF, the PCF, and the NEF.

### Satellites

FIG. 4 is a block diagram of the satellite 108A of the system environment 100 according to aspects of the disclosed technology. Each of the satellites, such as the satellite 108A, may be a communications satellite that may be configured to implement a 5G core network (5GC) 402 and a 5G base station, i.e., gNodeB (gNB) 404, that communicates with at least one UE of the plurality of UE 106. The satellite 108A further includes a flight software 406, a communication operation and management agent (OAM) 408, and a routing plane 410. The 5GC 402 may serve as a control center for the 5G communications network. The 5GC 402 may be configured to govern all the protocols, network interfaces, and services that allow the 5G communications network to function seamlessly. The 5GC 402 may comprise a third set of 5G components from the plurality of 5G components. In one embodiment, the third set of 5G components may include the AMF, the SMF, the UPF, the UDM, the UDR, and the AUSF.

As shown in FIG. 4, the 5GC 402 includes the AMF 412, the SMF 414, the UPF 416, the UDM 418, the UDR 420, the AUSF 422, a data buffer 424, and a 5GC OAM 526. The AMF 412 may be configured to manage access and mobility for 5G devices, such as the UE 106. The AMF 412 may be further configured to terminate a radio access network (RAN) control plane interface and handles non-access stratum (NAS) for authentication, registration, connection management, and mobility management. Additionally, the AMF 412 may provide transport for service messages between the UE 106 and the SMF 414, and manage location services. The SMF 414 may be configured to handle session management for user data in 5G communication networks. The SMF 414 may serve as an anchor point for intra-radio access technology (RAT) or inter-RAT mobility, manage subscriber profiles, policies, charging information, and packet routing. Additionally, the SMF 414 may enforce policy rules related to gating, redirection, and traffic steering.

The UPF 416 may be configured to handle user data traffic and acts as an external protocol data unit (PDU) session point of interconnect to the data network. The UPF 416 may be configured to perform packet routing, forwarding, inspection, and traffic usage reporting and ensure QoS enforcement, both for uplink and downlink traffic. The UDM 418 may be configured to manage subscriber data and user data profiles. The UDM 418 may store information related to authentication, authorization, and mobility, and interact with other functions to retrieve and enforce policy rules. The UDR 420 may serve as a centralized repository for user-related data. The UDR 420 may be configured to store subscription information, session context, and other relevant data associated with the 5G communication. The UDR 420 may support functions like charging, policy enforcement, and mobility management.

The AUSF 422 may be configured to handle authentication and key management and interact with the AMF 412 during the authentication process. The AUSF 422 may ensure secure communication between the UE 106 and the 5G communication network. In the context of the 5G core network, data buffering plays an important role in ensuring efficient communication and seamless handovers. The data buffer 424 may be configured to store the information associated with the 5G communication such as the user data profiles, the user context information, the information associated with initiation of connection with satellites, the information associated with resuming the connection, the information associated with restarting the connection, and the information associated with tearing down the connection. During communication sessions and handovers, the stored information in the data buffer 424 may be retrieved by the respective 5G component.

The 5GC OAM 526 may be configured to continuously monitor the 5GC network components, detecting any anomalies or faults, handle configuration changes for various network functions based on service requirements and policies. The 5GC OAM 526 may be further configured to monitor network performance metrics (such as latency, throughput, and resource utilization), security policies, access controls, and threat detection, facilitate software upgrades for network functions, and optimize resource usage to enhance overall network performance.

The gNB 404 on the satellite 108A is an important component of the satellite communication systems, serving as an access point for two-way data transmission between Earth-based UEs 106 and the satellites 108 as well as between two or more of the satellites 108. The gNB 404 may be housed within (or as part of) the satellite's payload and may include transceivers and antennas designed to facilitate seamless communication across vast distances. The gNB 404 plays a role in relaying, amplifying, and routing signals between terrestrial devices, such as the UEs 106, and the satellites 108, ensuring robust and efficient data transfer. The gNB 404 is often equipped with advanced signal processing g capabilities, enabling functions like modulation, demodulation, encoding, and decoding to optimize the quality and reliability of communication links 114, and can be important for various satellite-based services, including global broadband internet, broadcasting, navigation, internet of things (IoT) services, and Earth observation.

In one implementation, each satellite 108 may be a 5G Non-Terrestrial Network (NTN) satellite, in which case the gNB 404 may be referred to as a Third Generation Partnership Project (3GPP)-compliant implementation of the 5G base station. The gNodeB includes independent network functions, which implement 3GPP-compliant new radio (NR) radio access network (RAN) protocols namely.

As shown in FIG. 4, the gNB 404 includes a first layer corresponding a radio resource management (RRM) layer 428, a second layer 430 corresponding to at least one of a scheduler layer and a media access control (MAC) layer, a third layer corresponding to a radio link control (RLC) layer 432, a fourth layer 434 corresponding to at least one of a packet data convergence protocol (PDCP) layer and a service data adaptation (SDAP) layer, a fifth layer corresponding to a physical (PHY) layer 436, and a gNB OAM 438. The RRM layer 428 may be configured to manage radio resources (such as frequency, time, and power) to ensure optimal performance and perform functions including radio bearer setup, handover decisions, admission control, and interference management.

In one embodiment, the scheduler layer may be configured to allocate radio resources to different users and services, balance QoS requirements, fairness, and system capacity. In satellite networks, the scheduler layer may be configured to prioritize traffic based on satellite-specific constraints (e.g., beam coverage, rain fade, and the like). The MAC layer may be configured to control access to the shared radio channel and handle channel access methods (e.g., contention-based or scheduled), Hybrid Automatic Repeat Request (HARQ), and buffer management. The RLC layer 432 may be configured to ensure reliable data transfer between the UE 106 and gNB 404, and handle segmentation, reordering, and error correction associated with the data transfer.

The PDCP layer may be configured to handle header compression, encryption, and integrity protection to ensure efficient data transfer while maintaining security. The SDAP layer may be configured to manage QoS for different services (e.g., voice, video, data), map QoS flows to radio bearers, and enforce QoS policies. The PHY layer 436 may be responsible for the actual transmission and reception of wireless signals. The PHY layer 436 may be configured to handle modulation, coding, channel estimation, and adaptive modulation and coding (AMC). The gNB OAM 438 may be configured to manage efficient coordination, resource allocation, and seamless connectivity for 5G devices such as the UE 106.

The flight software 406 may be operated on a flight computer (not shown) to serve as the “brain” of the satellite 108A. For example, the flight software 406 may run on a processor embedded in a satellite's avionics. The name “flight software” reflects the location where it executes, i.e. in the satellite, to differentiate from “ground software”, which runs in the ground segment. The flight software 406 may enable the satellite to perform all operations necessary to facilitate the science objective and perform maintenance tasks for the satellite. For instance, the flight software 406 is responsible for managing on-board activities, data processing and satellite health and safety. It is considered a high-risk system because it interacts directly with satellite hardware, controlling virtually most of the onboard systems in real time at various levels of automation.

The flight software 406 may vary depending on the implementation. In general, the flight software 406 may include an operating system (OS) layer that interfaces with a middleware layer via OS application programming interfaces (APIs), and an application layer that interfaces with the middleware layer via middleware APIs. The OS APIs may be encapsulated and a uniform Application Program Interface (API) may be provided by the OS layer. Any operating system that supports this uniform API may be used in the avionics system. The middleware layer may serve as common service platform between the operating system layer and application layer. The middleware layer has standard program interfaces and protocols, and may realize the data exchange and cross support among different hardware and operating system. The application layer includes any mission application software or “mission applications.” The application layer includes most of the common functions of avionics system. The implementation of this layer may be different for different projects.

The communication OAM 408 may be configured to perform various task related to the satellite operations such as health monitoring to ensure the satellite's proper functioning, orbit control to adjusting the satellite's position and trajectory, payload management to optimizing payload usage, resource allocation to allocate bandwidth, power, and other resources, security, and fault detection and recovery. The routing plane 410 may handle data routing and forwarding of the data associated with the 5G communications between the centralized communication server 102 and the satellites 108 via the gateways 104 and data transfer between the satellites 108. In one embodiment, the satellite 108A may include a security plane that may ensure network security and protection against threats.

In one embodiment, the centralized communication server 102 may include the first set of 5G components, each gateway of the plurality of gateways 104 may include the second set of 5G components, and the 5GC 402 may include the third set of 5G components. The centralized communication server 102 may be configurable to transfer at least one of: a first subset of 5G components of the first set of 5G components from the first set of 5G components of the centralized communication server 102 to at least one of the second set of 5G components of each gateway and the third set of 5G components of the 5GC 402. Further, each gateway of the gateways 104 may be configurable to transfer at least one of: a second subset of 5G components of the second set of 5G components from the second set of 5G components of each gateway to at least one of the first set of 5G components of the centralized communication server 102 and the third set of 5G components of the 5GC 402. Furthermore, the 5GC 402 may be configurable to transfer at least one of: a third subset of 5G components of the third set of 5G components from the third set of 5G components of the 5GC 402 to at least one of the first set of 5G components of the centralized communication server 102 and the second set of 5G components of each gateway. As a result, the architecture of the 5G communication system presented in the system environment 100 is flexible such that the various functions of the 5G communication network may be configure to be performed by any one of the centralized communication server 102, each gateway 104, and the 5GC 402 individually or in combination. For example, the UPF 416 is unable to be configured on the 5GC 404 of the satellite 108, then the UPF 416 may be transferred to one of the gateway 104 and the centralized communication server 102 for configuration.

In one aspect of the present disclosure, the architecture of the 5G communication system presented in the system environment 100 is flexible such that the various functions of the 5G communication network may be configure to be performed by any of the centralized communication server 102, each gateway 104, and the 5GC 402 in combination. For example, the plurality of 5G components include a proxy PCF (not shown) and a master PCF (not shown). The third set of 5G components, i.e., the 5GC 404, may include the proxy PCF and one of the first set of 5G components, i.e., the centralized communication server 102, and the second set of 5G components, i.e., may include the master PCF.

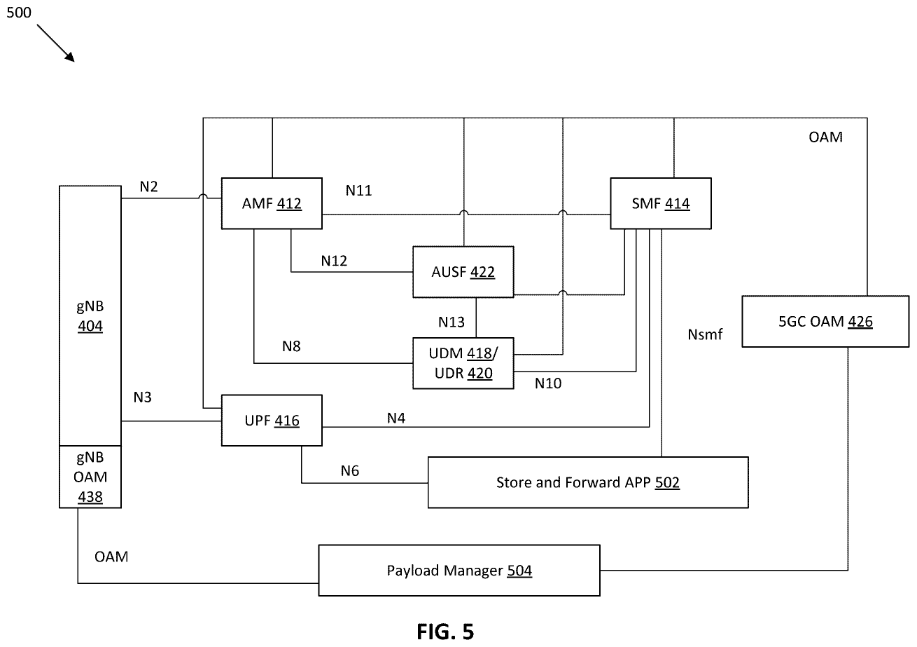

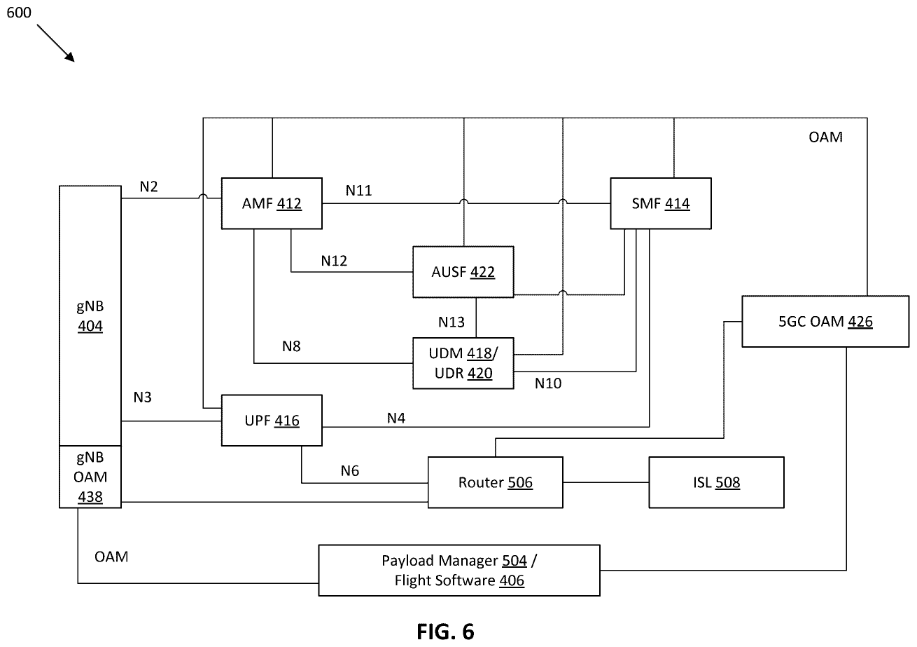

FIGS. 5 and 6 are block diagrams illustrating example 5G system architectures 500 and 600 according to aspects of the disclosed technology. Referring now to FIG. 5, the 5G system architecture 500 includes the AMF 412, the SMF 414, the UPF 416, the UDM 418, the UDR 420, the AUSF 422, the 5GC OAM 426, the gNB 404, the gNB OAM 438, a store and forward application (APP) 502, and a payload manager 504 in a specific architectural arrangement.

The gNB 404 is communicatively coupled to the AMF 412 by way of an interface N2 and to the UPF 416 by way of an interface N3. The UPF 416 is communicatively coupled to the SMF 414 by way of an interface N4 and to the store and forward APP 502 by way of an interface N6. The SMF 414 is communicatively coupled to the store and forward APP 502 by way of an interface Nsmf. The AMF 412 is communicatively coupled to at least one of the UDM 418 or the UDR 420 by way of an interface N8. At least one of the UDM 418 or the UDR 420 is communicatively coupled to the SMF 414 by way of an interface N10. The AMF 412 is communicatively coupled to the SMF 414 by way of an interface N11. The AMF 412 is communicatively coupled to the AUSF 422 by way of an interface N12. The AUSF 422 is communicatively coupled to at least one of the UDM 418 or the UDR 420 by way of an interface N13. The 5GC OAM 426 is communicatively coupled to the AMF 412, the SMF 414, the UPF 416, at least one of the UDM 418 and the UDR 420, the AUSF 422, and the payload manager 504 by way of an interface OAM. The gNB OAM 438 is communicatively coupled to the payload manager 504 by way of an interface OAM.

Referring now to FIG. 6, the 5G system architecture 600 includes the AMF 412, the SMF 414, the UPF 416, the UDM 418, the UDR 420, the AUSF 422, the 5GC OAM 426, the gNB 404, the gNB OAM 438, a router 506, an inter satellite link (ISL) 508, the payload manager 504, and the flight software 406 in a specific architectural arrangement.

The gNB 404 is communicatively coupled to the AMF 412 by way of an interface N2 and to the UPF 416 by way of an interface N3. The UPF 416 is communicatively coupled to the SMF 414 by way of an interface N4 and to the router 506 by way of an interface N6. The router is communicatively coupled with the ISL 508. The AMF 412 is communicatively coupled to at least one of the UDM 418 or the UDR 420 by way of an interface N8. At least one of the UDM 418 or the UDR 420 is communicatively coupled to the SMF 414 by way of an interface N10. The AMF 412 is communicatively coupled to the SMF 414 by way of an interface N11. The AMF 412 is communicatively coupled to the AUSF 422 by way of an interface N12. The AUSF 422 is communicatively coupled to at least one of the UDM 418 or the UDR 420 by way of an interface N13. The 5GC OAM 426 is communicatively coupled to the AMF 412, the SMF 414, the UPF 416, at least one of the UDM 418 and the UDR 420, the AUSF 422, and at least one of the payload manager 504 and the flight software 406 by way of an interface OAM. The gNB OAM 438 is communicatively coupled to at least one of the payload manager 504 and the flight software 406 by way of an interface OAM. The gNB OAM 438 is communicatively coupled to the router 506. In one embodiment, the ISL 508 shown is an intra plane ISL. The routing plane consists of a thin layer that takes care of classification and routing of traffic on the interface N6 (interface between the UPF 416 to the router 506) through ISLs or gateways 104.

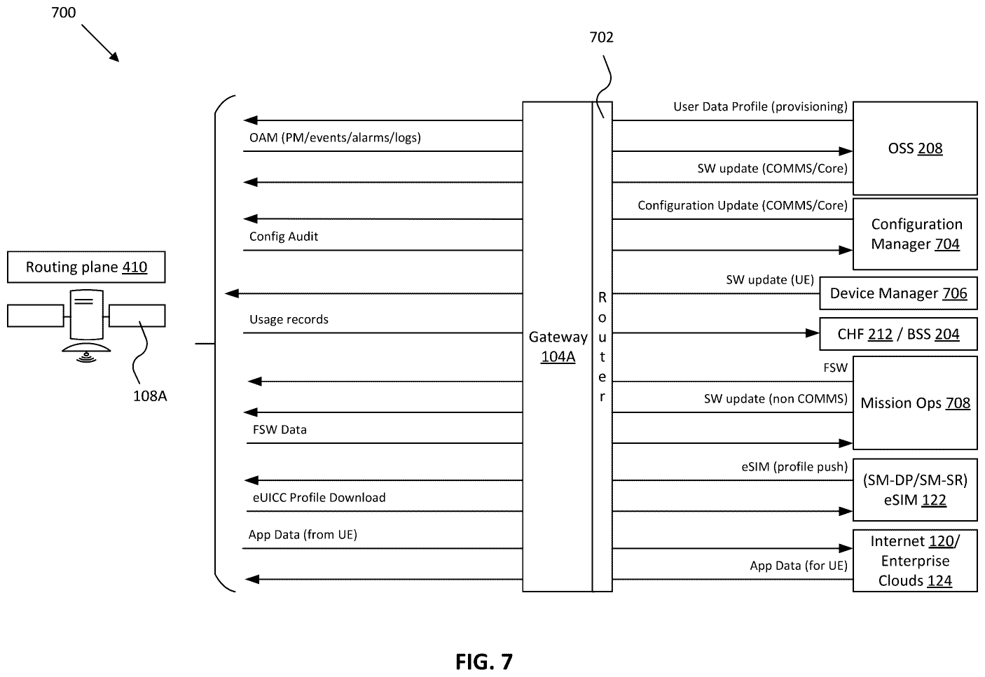

FIG. 7 is a block diagram 700 illustrating data flows through the gateway 104 and the satellite 108A according to aspects of the disclosed technology. The OSS 208 may be configured to provision user data profiles to the satellite 108A by way of the gateway 104A using a router 702. The router 702 may correspond to the routing plane 306 of the gateway 104A. The satellite 108A may receive the user data profiles via the routing plane 410 and transmit operations and management data related to the 5G communications such as events, alarms, logs, and the like. The OSS 208 may transmit software (SW) update to the satellite 108A associated with the 5GC 402.

Further, a configuration manager 704 may be configured to provide configuration update associated with the 5GC 402 to the satellite 108A by way of the gateway 104A. In response to the configuration update received, the satellite 108A may transmit configuration audit information to the configuration manager 704. A device manager 706 may be configured to provide SW update associated with the UE 106 or the communication devices to the satellite 108A by way of the gateway 104A. Based on the usage of the 5G communication network services by the corresponding UE 106 serviced by the satellite 108A, the satellite 108A transmits usage records to the CHF 212 or the BSS 204 for charging and billing functions.

Mission Operations (Mission Ops) 708 may be configured to provide flight software configuration and software update associated with the flight software 406 to the satellite 108A by way of the gateway 104A. In response, the satellite 108A may transmit the flight software data to the Mission Ops 708. The eSIM 122 may be configured to push user data profiles to the satellite 108A by way of the gateway 104A. In response, the satellite 108A may transmit the eUICC Profile download to the eSIM 122. The satellite 108A may be configured to route application data from the UE 106 to the Internet 120 or the enterprise clouds 124, such as the enterprise cloud 124A, by way of the gateway 104A. Similarly, the satellite 108A may be configured to receive application data for the UE 106 from the Internet 120 or the enterprise clouds 124, such as the enterprise cloud 124A, by way of the gateway 104A.

A 5G based regenerative LEO satellite constellation with an on-board subscriber database providing communication services to globally dispersed UE may require user data profiles of all the serviceable UE 106 to be available on the satellite 108 in order to authenticate the UE and authorize the use of communication services by the UE 106. Fetching such information (e.g., the user data profiles) from ground is costly in terms of time and use of spectrum or bandwidth. If information associated with all such UEs is known prior to service provisioning in the 5G communication network and there are no more UEs to be added to the 5G communication network, then in a simplest implementation all the user data profiles may be provisioned at once on all the satellites 108. However, the UEs to which the service needs to be provisioned may continuously change and a large number of UEs may be present to avail the 5G communication network services. Thus, due to the space or storage constraint on board the satellite 108 and constant acquisition and loss of customers in the 5G communication network above implementation may not be suitable for user data profile provisioning. Therefore, there is a need to intelligently provision the user data profiles in a regenerative LEO network such that only user data profiles which are required to serve the users/devices in a satellite's field of view (FoV) are made available. The FoV can be an expanded view (projected) covering areas (earth cells) where the satellite 108 is projected to provide coverage along the path.

The process of provisioning involves two steps in the 5G communication network. First is to create a user data profile in the system with placeholder attributes which are relevant to the actual product or service ordered and as such are updated at the time of purchase. Second is to provision the user data profile to the satellite 108 that may provide the 5G communication network. In this step a subscription is assigned to a user identifier, for example, international mobile subscriber identity (IMSI) assignment to Mobile Station International Subscriber Directory Number (MSISDN) or External Identifier. Only Active subscriptions need to be present on the 5GC 402 of the satellites 108 and hence, all subscriptions should be provisioned as inactive to start with in the G-UDR 210. The G-UDR 210 may be configured to support bulk provisioning where the profiles in bulk may be provisioned by the centralized communication server 102 on the ground. The G-UDR 210 may further be configured to expose APIs to create, delete, or modify user data profiles as individual or group operation. The centralized communication server 102 may be configured to utilize a template-based method to avoid duplicate and repeated information in the user data profiles. The templates may be part of G-UDR configuration and referred in every subscription in the provisioning files.

The “Service Profiles” (i.e., the templates) may be created based on subscription classes tied to the product or service purchased by the subscribers. A mapping between product and “Service Profile” must be created. The information that is dynamic in the subscription may be updated during the activation process. For example, initially all the user data profiles can be provisioned as “inactive” with a dummy identifier and dummy service profile. When a product is purchased, a user data profile may be updated with real subscriber's permanent identity (SUPI) allocated by the centralized communication server 102 and relevant service profile where service profile contains information on external Identifier, assigned “service area”, Data Network Name (DNN), Allowed Max Bit Rate (AMBR), Slice Identifier (S-NSSAI), Service type (IP/non-IP/both), default gateway, charging information, static IP address, and the like. “Service Area” here refers to a cell or collection on Earth 110 where the device or UE is likely to receive service.

All provisioning operations towards the satellite 108 may need to be coordinated with the Mission Ops 708 to time align the operations with satellite movements. As a result, a gateway may be assigned that may be used at pre-determined time to push user data profiles grouped by DNN or service area or a combination of both to the satellites 108. The operation may be configured to allow provisioning command to be completed before the satellite 108 may start providing coverage for relevant devices in the geographic coverage area. To save on bandwidth, two approaches may be implemented: compression of the user data profiles which may require decompression on board leading to higher processing power usage or utilization of templates to reduce the user data profile size.

The provisioning framework may allow following modifications in G-UDR to be reflected on the satellites such as suspension and resumption of service for a user (or a group of users), and any policy related changes in the subscription (e.g., reducing AMBR or QoS). The minimum information that is required to activate a user data profile at the time of service order is Subscription id (SUPI), User id (external identifier), Billing Account Id, Device Id, Policy information related to service class, Pool Id (if the subscription is part of a pool), Service Area, Default gateway, roaming restrictions (e.g., whether service allowed outside the service area/region), and the like.

The present disclosure provides a method to provision the user data profiles from the centralized communication server 102 to the satellites 108 by way of the gateways 104. The method includes classifying the user data profiles at the time of initial provisioning in the G-UDR 210 of the centralized communication server 102 by identifying their association with a specific geographical coverage area. The coverage area may span multiple cells on the Earth 110 if the UE 106 associated with those profiles are nomadic (i.e., service area comprising multiple earth cells). The method further includes pushing the user data profiles by the ground software (or pull from satellite software) to any satellite in a timely manner which would be covering the identified geographical area ahead of coverage start time. To provide the user data profiles in a timely manner, an input may be generated by the Mission Ops 708 to derive a timeline identifying which user data profiles need to be made available on a given satellite and through which gateway.

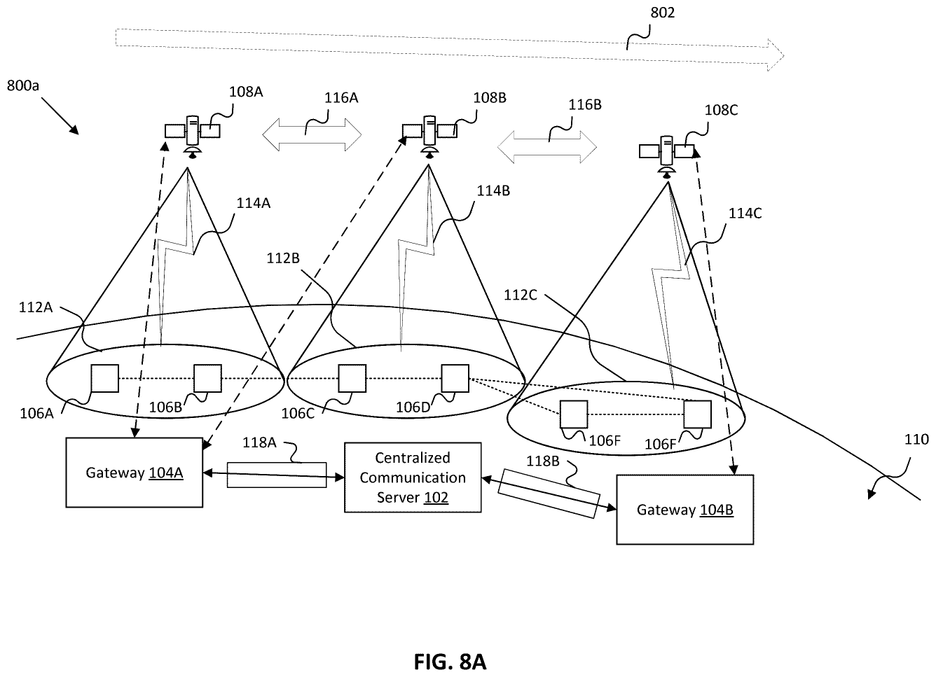

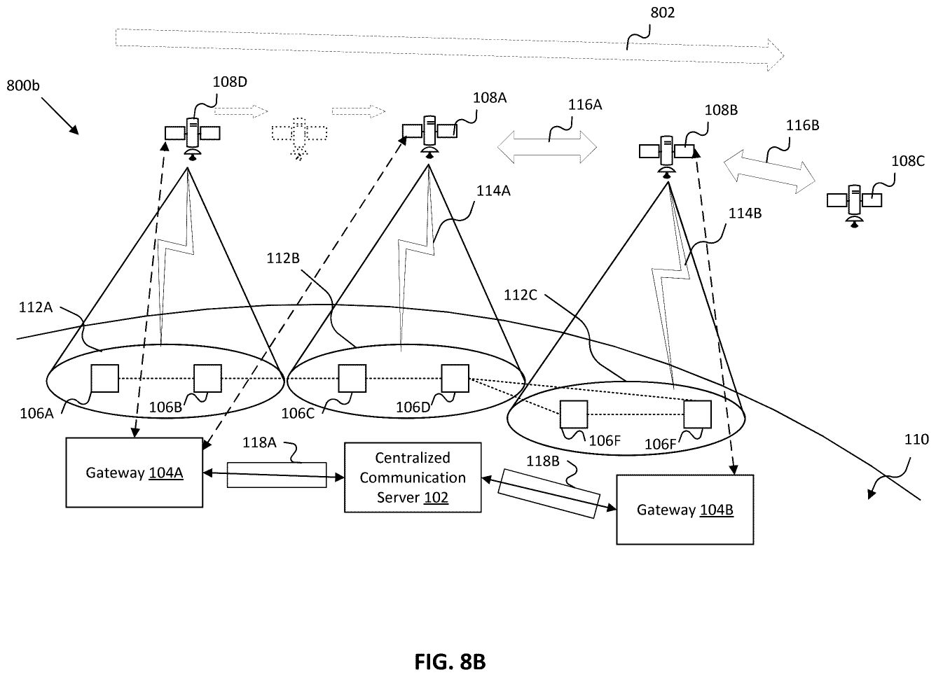

Software on-board the satellite 108 may receive the profiles from ground and optionally distribute the user data profiles to following satellite directly coupled through the inter satellite link (ISL). Further, the following satellite may receive profiles from the leading satellite and co-ordinate with the leading satellite on when to assume ownership of relevant user data profiles (i.e., either one of the satellites may be the master of a user data profile at any given point of time). The satellite software may run an algorithm to identify user data profiles which are no more relevant to the satellite's field of view (once the satellite has passed over that geographic coverage area) and discard such irrelevant user data profiles in co-ordination with the following satellite such that the user data profile or user context is not lost in orbit. The process of provisioning the user data profiles and user context from the ground to the satellites 108 via the gateways 104 and transfer of the user data profiles between the satellites 108 via ISLs is explained in detail in conjunction with the FIGS. 8A-10B.

FIGS. 8A and 8B are block diagrams 800a and 800b illustrating provisioning of data in a 5G communication network according to aspects of the disclosed technology. The 5G communication network corresponds to a low earth orbit (LEO) satellite based 5G communication network. The provisioning of data in the 5G communication network may be implemented in two stages. In the first stage, the centralized communication server 102 on the ground may provision data to the satellites 108 via one or more gateways 104. In the second stage, each satellite may provision the data to the following satellite via the ISL between the two satellites.

Provisioning of Data from Ground to Satellites Via Gateways

The centralized communication server 102 may be configured to store the plurality of user data profiles associated with the 5G communication network. Each user data profile comprises at least one of subscription data and policy data associated with a corresponding UE, such as the UEs 106A-106F, and indicates a type of service to be provisioned to the corresponding UE. The centralized communication server 102 determines at least one satellite, such as the satellite 108A, of a constellation of satellites 108 that provisions 5G communication network over a first region, i.e., the geographic coverage area 112A, on the Earth 110 during a first time interval. Each satellite of the constellation of satellites 108 is configured to implement a 5G core network, such as the 5GC 402, and a 5G base station, such as the gNB 404, that communicates with at least one UE, such as UE 106A and 106B, of the plurality of UE 106A-106F.

The centralized communication server 102 may be configured to identify a first set of user equipment, for example, the UE 106A and 106B, in the geographic coverage area 112A to be provisioned the 5G communication network by the satellite 108A. The geographic coverage area 112A corresponds to the geographic coverage area in the field of view of the satellite 108A during the first time interval. Additionally, the geographic coverage area 112A may include one of a country, a collection of countries, a portion of a country, a portion of oceans, and any combination thereof based on a coverage plan. Upon identification of the first set of UE, the centralized communication server 102 may be configured to retrieve a first set of user data profiles corresponding to the first set of UE from the G-UDR 210 of the centralized communication server 102.

The centralized communication server 102 may be further configured to determine at least a first gateway, such as the gateway 104A, of a plurality of gateways 104 that is in communication with the satellite 108A. Each gateway is communicatively coupled with the centralized communication server 102 and configured to: route and forward the communications between the centralized communication server 102 and the 5G core network of each satellite to facilitate the communications between the 5G base stations with the plurality of UE 106.

Upon determination of the gateway 104A for routing and forwarding the communications, the centralized communication server 102 may be configured to provision the first set of user data profiles to the satellite 108A via the first gateway 104A before the satellite 108A reaches the geographic coverage area 112A, thereby enabling the satellite 108A to provision the 5G communication network to the first set of UE 106A and 106B based on the first set of user data profiles. In one embodiment, the first set of user data profiles is provisioned to the satellite 108A via the routing plane 218 of the centralized communication server 102 and the routing plane 306 of the first gateway 104A.

The satellite 108A may utilize the first set of user data profiles for at least one of registration management, authentication, authorization, session management, charging, billing, service access, and mobility management associated with the 5G communication network for the first set of UE 106A and 106B. Similarly, the centralized communication server 102 may provision user data profiles corresponding to the UEs 106C and 106D to the satellite 108B via the gateway 104A before the satellite 108B reaches a second region, i.e., the geographic coverage area 112B, such that the satellite 108B provisions the 5G communication network to the UEs 106B and 106D. The centralized communication server 102 may provision user data profiles corresponding to the UEs 106E and 106F to the satellite 108C via the gateway 104B before the satellite 108C reaches a third region, i.e., the geographic coverage area 112C, such that the satellite 108C provisions the 5G communication network to the UEs 106E and 106F. The satellites 108B and 108C provision the 5G communication network over the geographic coverage area 112B and the geographic coverage area 112C during the first time interval. It will be apparent to a person skilled in the art that although in the current embodiment, only three satellites 108A-108C in the constellation of satellites 108 and six UEs 106A-106F are shown, in alternate embodiment, there may be any suitable number of satellites in the constellation and any suitable number of UEs on the Earth 110 and within each coverage area 112, without deviating from the scope of the present disclosure.

Additionally, in one embodiment, the centralized communication server 102 stores a first set of user information associated with the first set of user data profiles in the centralized communication server by a previous satellite, i.e., the satellite 108B, of the constellation of satellites as the satellite 108B provisions the 5G communication network to the first set of UE 106A and 106B during a previous time interval. Each user information of the first set of user information includes authentication information associated with the UE, registration information generated at completion of registration of the UE with the previous satellite, session setup information generated during session establishment procedures between the UE and the previous satellite, control context and user plane context required to continue a communication session of the UE on the 5G communication network provisioned by the previous satellite, and charging data associated with the communication session. The centralized communication server 102 may be configured to provision the first set of user information to the satellite 108A via the gateway 104A before the satellite 108A reaches the geographic coverage area 112A. The satellite 108A may utilize the first set of user data profiles and the first set of user information to provision various services associated with the 5G communication network to the UEs 106a and 106B.

Further, the satellite 108A generates a second set of user information associated with the first set of user data profiles as the satellite 108A provisions the 5G communication network to the first set of UE 106A and 106B during the first time interval and provisions the second set of user information to the centralized communication server 102 via the first gateway 104A. The satellites 108A-108C are continuously moving in an orbit around the Earth 110 in a direction shown by an arrow 802. Thus, each satellite may provision the 5G communication network in a particular geographic coverage area for a limited time duration.

Referring now to FIG. 8B, the satellites 108A-108C move towards the direction of the arrow 802 along their respective orbits around the Earth 110. The centralized communication server 102 may be configured to determine a movement of the satellite 108A such that the satellite 108A provisions 5G communication network over the second region, i.e., the geographic coverage area 112B, on the Earth 110 and leave the geographic coverage area 112A during a second time interval. The second region corresponds to the geographic coverage area 112B within the field of view of the satellite 108A during the second time interval. The second region may include one of a country, a collection of countries, a portion of a country, a portion of oceans, and any combination thereof based on a coverage plan.

The central communication server 102 may be further configured to identify the second set of UE 106C and 106D in the geographical coverage area 112B to be provisioned the 5G communication network by the satellite 108B and retrieve the second set of user data profiles corresponding to the second set of UE 106C and 106D. Upon retrieval of the second set of user data profiles, the centralized communication server 102 may be configured to provision the second set of user data profiles to the satellite 108A via the first gateway 104A before the satellite 108A reaches the geographical coverage area 112B, thereby enabling the satellite 108A to provision the 5G communication network to the second set of UE 106C and 106D based on the second set of user data profiles. Further, the centralized communication server 102 may be configured to provision the second set of user information from the satellite 108A to a next satellite 108D via at least the first gateway 104A and the centralized communication server 102 before the next satellite 108D reaches the geographical coverage area 112A. The provisioning of the second set of user information from the satellite 108A to the next satellite 108D ensures continuity in the communication session of the UE 106A or 106B on the 5G communication network during handover of coverage from the satellite 108A to the next satellite 108D.

In one exemplary embodiment of the present disclosure, the centralized communication server 102 may be configured to determining whether communication between the first gateway 104A and the satellite 108A is terminated. When the termination of the communication is determined, the centralized communication server 102 may determine at least a second gateway, i.e., gateway 104B, of the plurality of gateways 104 that is in communication with the satellite 108A when the communication between the first gateway 104A and the satellite 108A is terminated. In this embodiment, the centralized communication server 102 may be configured to provision the second set of user data profiles to the satellite 108A via the second gateway 104B before the satellite 108A reaches the geographical coverage area 112B, thereby enabling the satellite 108A to provision the 5G communication network to the second set of UE 106C and 106D based on the second set of user data profiles.

In another exemplary embodiment, multiple gateways may be communicatively coupled between the first gateway 104A and the centralized communication server 102. In the embodiment, the centralized communication server 102 may be configured to determine a set of gateways (not shown) from the plurality of gateways coupled between the centralized communication server 102 and the first gateway 104A when the first gateway 104A is coupled to the centralized communication server 102 by way of the set of gateways. Upon determination of the set of gateways, the centralized communication server 102 may be configured route the first or second set of user data profiles from the centralized communication server 102 to the first gateway 104A via the set of gateways to provision the first or second set of user data profiles to the satellite 108 via the first gateway 104A.

### Provisioning of Data Between Satellites Via ISL

The satellite 108B may be configured to determine a movement of the satellite 108B such that the satellite 108B provisions 5G communication network over the third region, i.e., the geographic coverage area 112C, on the Earth 110 and leave the geographic coverage area 112B during the second time interval. The satellite 108B may be configured to identify at least a second satellite, i.e., the satellite 108A, of the constellation of satellites 108 that provisions 5G communication network over the geographic coverage area 112B on the Earth 110 during the second time interval. Upon identification of the satellite 108A, the satellite 108B may be configured to provision the second set of user data profiles to the satellite 108A via the intersatellite link (ISL) 116A between the satellite 108B and the satellite 108A before the satellite 108A reaches the geographic coverage area 112B, thereby enabling the satellite 108A to provision the 5G communication network to the UE 106C and 106D based on the user data profiles associated with the UE 106C and 106D.

Further, the satellite 108B may be configured to generate a plurality of user information associated with the second set of user data profiles as the satellite 108B provisions the 5G communication network to the UE 106C and 106D during the first time interval. Along with the second set of user data profiles, the satellite 108B may be further configured to provision the first set of user information to the satellite 108A via the intersatellite link 116A between the satellite 108B and the satellite 108A before the satellite 108A reaches the geographic coverage area 112B. The provisioning of the first set of user information from the satellite 108B to the satellite 108A via the intersatellite link 116A ensures continuity in the communication session of the UE 106C or 106D on the 5G communication network during handover of coverage from the satellite 108B to the satellite 108A. Additionally, the satellite 108B may be configured to provision the first set of user information to the centralized communication server 102 via the gateway 104A of the plurality of gateways 104.

In one embodiment, when a probability of the satellite 108B provisioning the 5G communication network to the UE 106C and 106D is greater than a probability of the satellite 108A provisioning the 5G communication network to the UE 106C and 106D, the satellite 108B is a master satellite for the second set of user data profiles. When a satellite is a master satellite for a set of user data profiles, the satellite may not discard the set of user data profiles. On movement of the satellite 108B from the geographic coverage area 112B to geographic coverage area 112C and the movement of the satellite 108A from the geographic coverage area 112A to geographic coverage area 112B, the probability of the satellite 108B serving the UE 106C and 106D decreases and the probability of the satellite 108A servicing the UE 106C and 106D increases.

When the probability of the satellite 108B provisioning the 5G communication network to the UE 106C and 106D is less than the probability of the satellite 108A provisioning the 5G communication network to the UE 106C and 106D, the satellite 108A is a master satellite for the second set of user data profiles. As the satellite 108B is no longer the master satellite for the second set of user data profiles associated with the UE 106C and 106D, the satellite 108B may discard the corresponding user data profiles that are irrelevant.

In one embodiment, the satellite 108B may be configured to identify a set of irrelevant user data profiles from the second set of user data profiles when the probability of the satellite 108B provisioning the 5G communication network to the UE 106C and 106D is less than the probability of the satellite 108A provisioning the 5G communication network to the UE 106C and 106D. Upon identification of the set of irrelevant user data profiles, the satellite 108B may be configured to discard the set of irrelevant user data profiles. For example, when the UE 106C is no longer in the field of view of the satellite 108B and the satellite 108B has provisioned the user data profile and user information associated with the UE 106C to respective following satellite, the satellite 108B may discard the user data profile associated with the UE 106C from the user data profiles of the UE 106C and 106D stored in the satellite 108B. Similar process may be followed by the satellites 108A and 108C to provision the user data profiles to other satellites via the ISL and discard the irrelevant user data profiles.

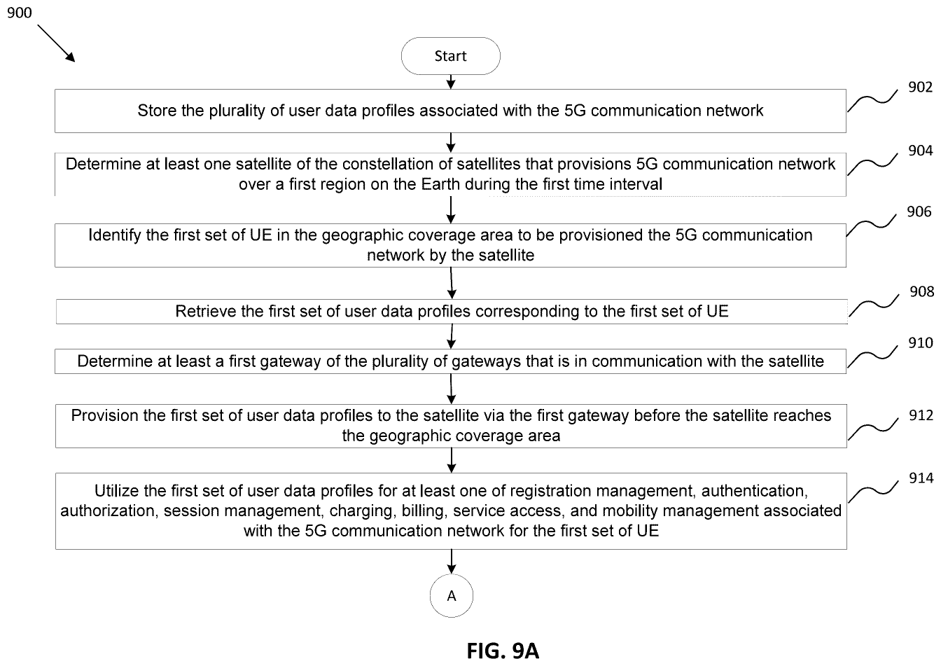

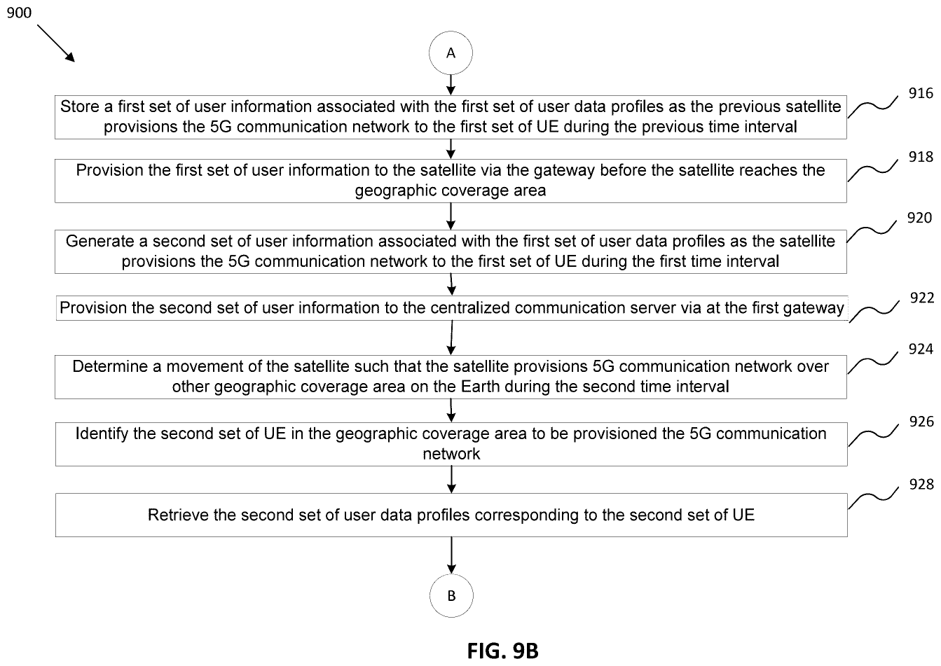

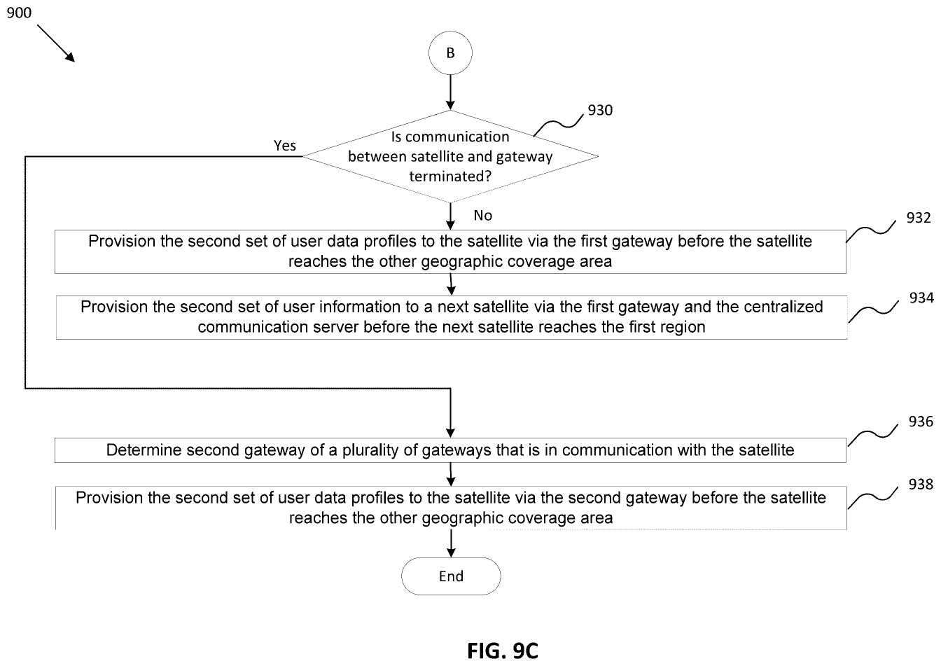

FIGS. 9A-9C, collectively, represent a flow chart 900 illustrating one example of a method of provisioning data provisioning data in the 5G communication network according to aspects of the disclosed technology. With respect to FIGS. 9A-9C, the steps of each method shown are not necessarily limiting. Steps can be added, omitted, and/or performed simultaneously without departing from the scope of the appended claims. Each method may include any number of additional or alternative tasks, and the tasks shown need not be performed in the illustrated order. Each method may be incorporated into a more comprehensive procedure or process having additional functionality not described in detail herein. Moreover, one or more of the tasks shown could potentially be omitted from an embodiment of each method as long as the intended overall functionality remains intact. Further, each method is computer-implemented in that various tasks or steps that are performed in connection with each method may be performed by software, hardware, firmware, or any combination thereof. For illustrative purposes, the following description of each method may refer to elements mentioned above in connection with FIGS. 1-8B. In certain embodiments, some or all steps of this process, and/or substantially equivalent steps, are performed by execution of processor-readable instructions stored or included on a processor-readable medium. For instance, in the description of FIGS. 9A-9C that follows, the UE(s), the gNBs, the 5GCs, the satellites, centralized communication server, etc. may be described as performing various acts, tasks or steps, but it should be appreciated that this refers to processing system(s) of these entities executing instructions to perform those various acts, tasks or steps. Depending on the implementation, some of the processing system(s) can be centrally located, or distributed among a number of server systems that work together. Furthermore, in the description of FIGS. 9A-9C, a particular example is described in which the centralized communication server 102 provisions data to the satellites 108 by way of the gateways 104 by interacting with other elements of the system environment 100.

At 902, the centralized communication server 102 may store the plurality of user data profiles associated with the 5G communication network. Each user data profile includes at least one of subscription data and policy data associated with a corresponding UE and indicates a type of service to be provisioned to the corresponding UE.

At 904, the centralized communication server 102 may determine at least one satellite, such as the satellite 108A, of the constellation of satellites 108 that provisions 5G communication network over a first region, i.e., the geographic coverage area 112A, on the Earth 110 during the first time interval. The first region corresponds to a coverage area of the satellite 108A during the first time interval, and may comprise one of a country, a collection of countries, a portion of a country, a portion of oceans, and any combination thereof based on a coverage plan.

At 906, the centralized communication server 102 may identify the first set of UE 106A and 106B in the geographic coverage area 112A to be provisioned the 5G communication network by the satellite 108A. At 908, the centralized communication server 102 may retrieve the first set of user data profiles corresponding to the first set of UE 106A and 106B. At 910, the centralized communication server 102 may determine at least a first gateway, such as the gateway 104A, of the plurality of gateways 104 that is in communication with the satellite 108. Each gateway is configured to: route and forward the communications between the centralized communication server 102 and the 5G core network of each satellite to facilitate the communications between the 5G base stations with the plurality of UE.

At 912, the centralized communication server 102 may provision the first set of user data profiles to the satellite 108A via the first gateway 104A before the satellite 108A reaches the first region (the geographic coverage area 112A), thereby enabling the satellite 108A to provision the 5G communication network to the first set of UE 106A and 106B based on the first set of user data profiles. At 914, the satellite 108A may utilize the first set of user data profiles for at least one of registration management, authentication, authorization, session management, charging, billing, service access, and mobility management associated with the 5G communication network for the first set of UE 106A and 106B.

At 916, a previous satellite, i.e., the satellite 108B, may store a first set of user information associated with the first set of user data profiles as the satellite 108B provisions the 5G communication network to the first set of UE 106A and 106B during the previous time interval. At 918, the centralized communication server 102 may provision the first set of user information to the satellite 108A via the gateway 104A before the satellite 108A reaches the geographic coverage area 112A. At 920, the satellite 108A may generate a second set of user information associated with the first set of user data profiles as the satellite 108A provisions the 5G communication network to the first set of UE 106A and 106B during the first time interval. At 922, the satellite 108B may provision the second set of user information to the centralized communication server 102 via at the first gateway 104A.

At 924, the centralized communication server 102 may determine a movement of the satellite 108A such that the satellite 108A provisions 5G communication network over a second region, i.e., the geographic coverage area 112B, on the Earth 110 during the second time interval. At 926, the centralized communication server 102 may identify the second set of UE 106C and 106D in the geographic coverage area 112B to be provisioned the 5G communication network by the satellite 108A. At 928, the centralized communication server 102 may retrieve the second set of user data profiles corresponding to the second set of UE 106C and 106D.

At 930, the centralized communication server 102 determines whether the communication between the satellite 108A and the first gateway 104A is terminated. If at 930, the centralized communication server 102 determines that the communication between the satellite 108A and the first gateway 104A is not terminated, 932 is executed. At 932, the centralized communication server 102 may provision the second set of user data profiles to the satellite 108A via the first gateway 104A before the satellite 108A reaches the geographic coverage area 112B, thereby enabling the satellite 108A to provision the 5G communication network to the second set of UE 106C and 106B based on the second set of user data profiles.

At 934, the satellite 108A may provision the second set of user information to a next satellite, such as the satellite 108D, via the first gateway 104A and the centralized communication server 102 before the next satellite 108D reaches the first region. The provisioning of the second set of user information from the satellite 108A to the next satellite 108D ensures continuity in the communication session of the user equipment on the 5G communication network during handover of coverage from the satellite 108A to the next satellite 108D.

If at 930, the centralized communication server 102 determines that the communication between the satellite 108A and the first gateway 104A is terminated, 936 is executed. At 936, the centralized communication server 102 may determine at least a second gateway 104B of a plurality of gateways 104 that is in communication with the satellite 108A when the communication between the first gateway 104A and the satellite 108B is terminated. At 938, the centralized communication server 102 may provision the second set of user data profiles to the satellite 108A via the second gateway 104B before the satellite 108A reaches the geographic coverage area 112B, thereby enabling the satellite 108A to provision the 5G communication network to the second set of UE 106C and 106D based on the second set of user data profiles.

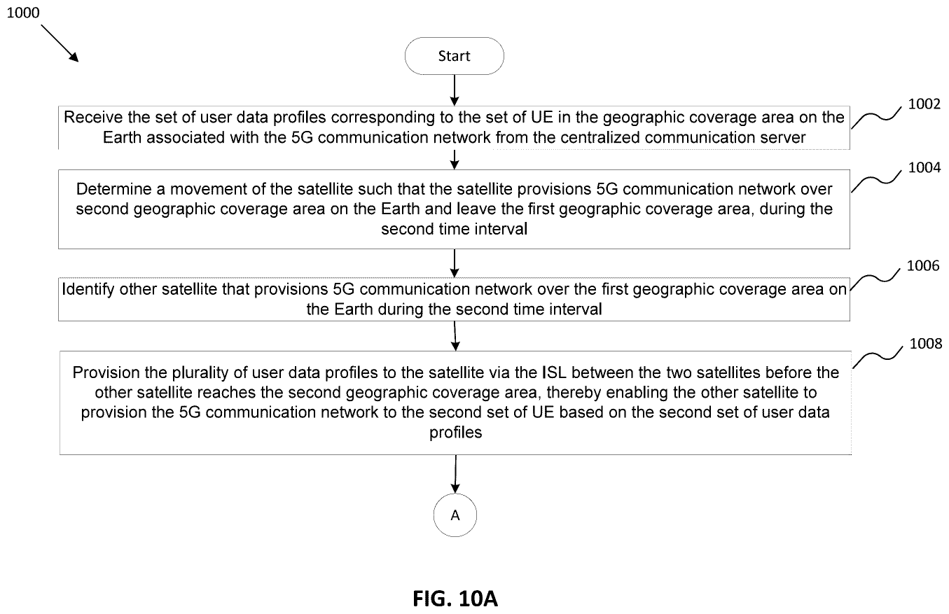

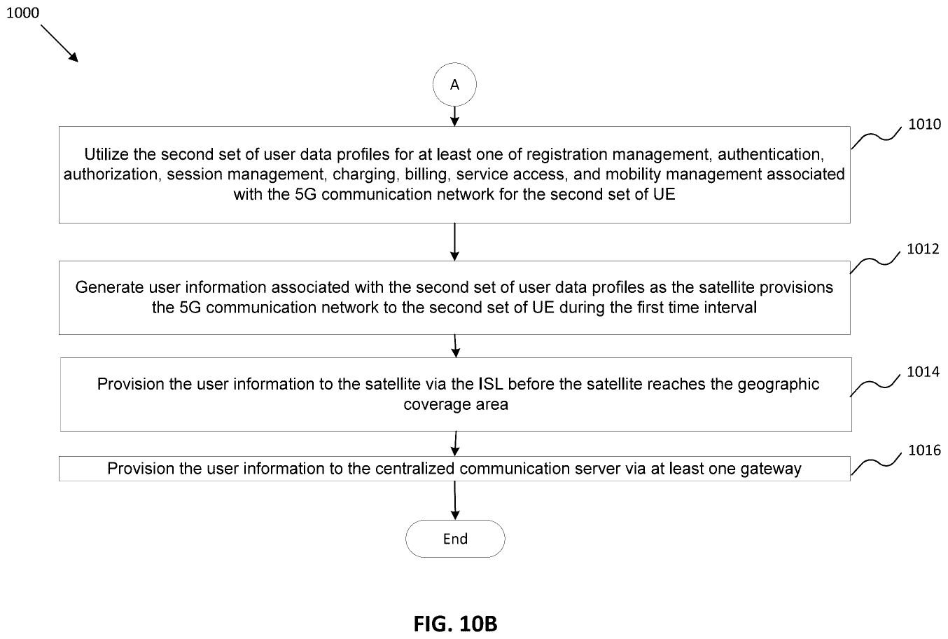

FIGS. 10A and 10B, collectively, represent a flow chart 1000 illustrating another example of a method of provisioning data provisioning data in the 5G communication network according to aspects of the disclosed technology. With respect to FIGS. 10A and 10B, the steps of each method shown are not necessarily limiting. Steps can be added, omitted, and/or performed simultaneously without departing from the scope of the appended claims. Each method may include any number of additional or alternative tasks, and the tasks shown need not be performed in the illustrated order. Each method may be incorporated into a more comprehensive procedure or process having additional functionality not described in detail herein. Moreover, one or more of the tasks shown could potentially be omitted from an embodiment of each method as long as the intended overall functionality remains intact. Further, each method is computer-implemented in that various tasks or steps that are performed in connection with each method may be performed by software, hardware, firmware, or any combination thereof. For illustrative purposes, the following description of each method may refer to elements mentioned above in connection with FIGS. 1-8B. In certain embodiments, some or all steps of this process, and/or substantially equivalent steps, are performed by execution of processor-readable instructions stored or included on a processor-readable medium. For instance, in the description of FIGS. 9A-9C that follows, the UE(s), the gNBs, the 5GCs, the satellites, centralized communication server, etc. may be described as performing various acts, tasks or steps, but it should be appreciated that this refers to processing system(s) of these entities executing instructions to perform those various acts, tasks or steps. Depending on the implementation, some of the processing system(s) can be centrally located, or distributed among a number of server systems that work together. Furthermore, in the description of FIGS. 10A and 10B, a particular example is described in which a satellite provisions data to other satellites 108 by way of the ISL between the satellites by interacting with other elements of the system environment 100.

At 1002, the satellite 108B may receive the second set of user data profiles corresponding to the second set of UE 106C and 106D in the geographic coverage area 112B on the Earth 110 associated with the 5G communication network from the centralized communication server 102. The satellite 108B provisions 5G communication network over the geographic coverage area 112B during the first time interval.

At 1004, the satellite 108B may determine a movement of the satellite 108B such that the satellite 108B provisions 5G communication network over a second region, i.e., the geographic coverage area 112C, on the Earth 110 and leave the first region, i.e., the geographic coverage area 112B, during the second time interval. At 1006, the satellite 108B may identify the satellite 108A that provisions 5G communication network over the geographic coverage area 112B on the Earth 110 during the second time interval.

At 1008, the satellite 108B may provision the plurality of user data profiles to the satellite 108A via the ISL 116A between the satellites 108B and 108A before the satellite 108A reaches the geographic coverage area 112B, thereby enabling the satellite 108B to provision the 5G communication network to the second set of UE 106C and 106D based on the second set of user data profiles.

At 1010, the satellite 108A may utilize the second set of user data profiles for at least one of registration management, authentication, authorization, session management, charging, billing, service access, and mobility management associated with the 5G communication network for the second set of UE 106C and 106D. At 1012, the satellite 108B may generate user information associated with the second set of user data profiles as the satellite 108B provisions the 5G communication network to the second set of UE 106C and 106D during the first time interval.

At 1014, the satellite 108B may provision the user information to the satellite 108A via the ISL 116A before the satellite 108A reaches the geographic coverage area 112B. The provisioning of the user information from the satellite 108B to the satellite 108A ensures continuity in the communication session of the user equipment on the 5G communication network during handover of coverage from the satellite 108B to the satellite 108A.

At 1016, the satellite 108B may provision the user information to the centralized communication server 102 via at least one gateway 104A. At 1018, the satellite 108B may identify a set of irrelevant user data profiles from the second set of user data profiles when a probability of the satellite 108B provisioning the 5G communication network to the second set of UE is less than a probability of the satellite 108A provisioning the 5G communication network to the second set of UE. At 1020, the satellite 108B may discarding the set of irrelevant user data profiles.

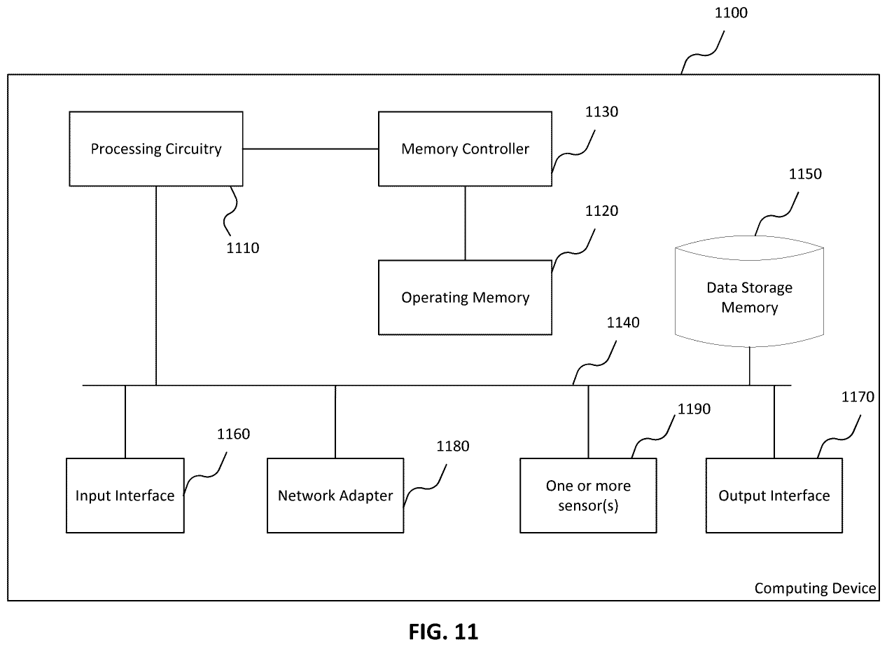

FIG. 11 is a diagram illustrating one example of computing device 1100 in which aspects of the technology may be practiced. Computing device 1100 may be virtually any type of general-purpose or specific-purpose computing device. For example, computing device 1100 may be an example of the centralized communication server 102 or a processor of the satellite 108, a computing system or device associated with any entity (e.g., UE 106, satellite 108) as described above with reference to FIGS. 1-10.

As illustrated in FIG. 11, computing device 1100 includes processing circuit 1110, operating memory 1120, memory controller 1130, data storage memory 1150, input interface 1160, output interface 1170, one or more network adapter(s) 1180, and in some embodiments, one or more sensor(s) 1190. Each of these afore-listed components of computing device 1100 includes at least one hardware element.

Computing device 1100 includes at least one processing circuit 1110 configured to execute instructions, such as instructions for implementing the herein-described workloads, processes, or technology. Processing circuit 1110 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 1120 during run-time of computing device 1100. Operating memory 1120 may also include any of a variety of data storage devices/components, such as volatile memories, semi-volatile memories, random access memories, static memories, caches, buffers, or other media used to store run-time information. In one example, operating memory 1120 does not retain information when computing device 1100 is powered off. Rather, computing device 1100 may be configured to transfer instructions from a non-volatile data storage component (e.g., data storage memory 1150) to operating memory 1120 as part of a booting or other loading process. In some examples, other forms of execution may be employed, such as execution directly from data storage memory 1150.

Operating memory 1120 may include 4th generation double data rate (DDR4) memory, 3rd generation double data rate (DDR3) memory, other dynamic random access memory (DRAM), High Bandwidth Memory (HBM), Hybrid Memory Cube memory, 3D-staked memory, static random access memory (SRAM), magneto resistive random access memory (MRAM), pseudorandom random access memory (PSRAM), or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 1110 via memory controller 1130 in channels. One example of computing device 1100 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above discussion, operating memory 1120 specifically does not include or encompass communications media, any communications medium, or any signals per se.

Memory controller 1130 is configured to interface processing circuit 1110 to operating memory 1120. For example, memory controller 1130 may be configured to interface commands, addresses, and data between operating memory 1120 and processing circuit 1110. Memory controller 1130 may also be configured to abstract or otherwise manage certain aspects of memory management from or for processing circuit 1110. Although memory controller 1130 is illustrated as single memory controller separate from processing circuit 1110, in other examples, multiple memory controllers may be employed, memory controller(s) may be integrated with operating memory 1120, or the like. Further, memory controller(s) may be integrated into processing circuit 1110. These and other variations are possible.

In computing device 1100, data storage memory 1150, input interface 1160, output interface 1170, network adapters 1180, and sensors 1190 may be interfaced to processing circuit 1110 by bus 1140. Although, FIG. 11 illustrates bus 1140 as a single passive bus, other configurations, such as a collection of buses, a collection of point-to-point links, an input/output controller, a bridge, other interface circuitry, or any collection thereof may also be suitably employed for interfacing data storage memory 1150, input interface 1160, output interface 1170, or network adapters 1180 to processing circuit 1110.

In computing device 1100, data storage memory 1150 is employed for long-term non-volatile data storage. Data storage memory 1150 may include any of a variety of non-volatile data storage devices/components, such as non-volatile memories, disks, disk drives, hard drives, solid-state drives, or any other media that can be used for the non-volatile storage of information. However, data storage memory 1150 specifically does not include or encompass communications media, any communications medium, or any signals per se. In contrast to operating memory 1120, data storage memory 1150 is employed by computing device 1100 for non-volatile long-term data storage, instead of for run-time data storage.

Also, computing device 1100 may include or be coupled to any type of processor-readable media such as processor-readable storage media (e.g., operating memory 1120 and data storage memory 1150) and communication media (e.g., communication signals and radio waves). While the term processor-readable storage media includes operating memory 1120 and data storage memory 1150, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 1100 also includes input interface 1160, which may be configured to enable computing device 1100 to receive input from users or from other devices, such as sensors 1190, in some embodiments. In addition, computing device 1100 includes output interface 1170, which may be configured to provide output from computing device 1100.

In the illustrated example, computing device 1100 is configured to communicate with other computing devices or entities via network adapters 1180. Network adapters 1180 may include a wired network adapter, e.g., an Ethernet adapter, a Token Ring adapter, or a Digital Subscriber Line (DSL) adapter. Network adapters 1180 may also include a wireless network adapter, for example, a Wi-Fi adapter, a Bluetooth adapter, a ZigBee adapter, a Long-Term Evolution (LTE) adapter, SigFox, LoRa, Powerline, or a 5G adapter.

Although computing device 1100 is illustrated with certain components configured in a particular arrangement, these components and arrangement are merely one example of a computing device in which the technology may be employed. In other examples, data storage memory 1150, input interface 1160, output interface 1170, or network adapters 1180 may be directly coupled to processing circuit 1110, or be coupled to processing circuit 1110 via an input/output controller, a bridge, or other interface circuitry. Other variations of the technology are possible.

Some examples of computing device 1100 include at least one memory (e.g., operating memory 1120) adapted to store run-time data and at least one processor (e.g., processing circuit 1110) that is adapted to execute processor-executable code that, in response to execution, enables computing device 1100 to perform actions, where the actions may include, in some examples, actions for one or more methodologies or processes described herein, such as, method 900 of FIGS. 9A-9C and method 1000 of FIGS. 10A and 10B, as described above.

In some embodiments, when the device or system include one or more sensors 1190, the sensors may be configured to sense or gather data pertaining to the surrounding environment or operation of the device or system. Some exemplary sensors capable of being electronically coupled with the device or system of the present disclosure (either directly connected to the device or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; photo/Light sensors sensing ambient light intensity, ambient, day/night, UV exposure; TV/IR sensors sensing light wavelength; temperature sensors sensing machine or motor temperature, ambient air temperature, and environmental temperature; and moisture sensors for sensing surrounding moisture levels.

The device or system of the present disclosure may include wireless communication logic coupled to sensors on the device or system. The sensors gather data and provide the data to the wireless communication logic. Then, the wireless communication logic may transmit the data gathered from the sensors to a remote device. Thus, the wireless communication logic may be part of a broader communication system, in which one or several devices or systems of the present disclosure may be networked together to report alerts and, more generally, to be accessed and controlled remotely. Depending on the types of transceivers installed in the device or system of the present disclosure, the system may use a variety of protocols (e.g., Wifi, ZigBee, MiWi, Bluetooth) for communication. In one example, each of the devices or systems of the present disclosure may have its own IP address and may communicate directly with a router or gateway. This would typically be the case if the communication protocol is WiFi.

In another example, a point-to-point communication protocol like MiWi or ZigBee is used. One or more of the device or system of the present disclosure may serve as a repeater, or the devices or systems of the present disclosure may be connected together in a mesh network to relay signals from one device or system to the next. However, the individual device or system in this scheme typically would not have IP addresses of their own. Instead, one or more of the devices or system of the present disclosure communicates with a repeater that does have an IP address, or another type of address, identifier, or credential that may be needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system also allows individuals to access the device or system of the present disclosure for configuration and diagnostic purposes. In that case, the individual processors or microcontrollers of the device or system of the present disclosure may be configured to act as Web servers that use a protocol like hypertext transfer protocol (HTTP) to provide an online interface that can be used to configure the device or system. In some embodiments, the systems may be used to configure several devices or systems of the present disclosure at once. For example, if several devices or systems are of the same model and are in similar locations in the same location, it may not be to configure the devices or systems individually. Instead, an individual may provide configuration information, including baseline operational parameters, for several devices or systems at once.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software-controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not necessarily all embodiments, of the disclosure. The various appearances “an embodiment,” “one embodiment,” “some embodiments,” “one particular embodiment,” “an example embodiment,” “an exemplary embodiment,” or “other embodiments,” or the like, are not necessarily all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. As used herein in the specification and claims, including as used in the examples and unless otherwise expressly specified, numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed:

1. A method for provisioning data in a fifth generation (5G) communication network, comprising:
storing a plurality of user data profiles associated with the 5G communication network in a centralized communication server;
determining at least one satellite of a constellation of satellites that provisions 5G communication network over a first region on the Earth during a first time interval;
identifying a first set of user equipment in the first region to be provisioned the 5G communication network by the at least one satellite;
retrieving a first set of user data profiles corresponding to the first set of user equipment from the centralized communication server;
determining at least a first gateway of a plurality of gateways that is in communication with the at least one satellite, wherein each gateway is communicatively coupled with the centralized communication server; and
provisioning the first set of user data profiles from the centralized communication server to the at least one satellite via the first gateway before the at least one satellite reaches the first region, thereby enabling the at least one satellite to provision the 5G communication network to the first set of user equipment based on the first set of user data profiles.

2. The method of claim 1, further comprising:
determining a movement of the at least one satellite such that the at least one satellite provisions 5G communication network over a second region on the Earth during a second time interval, wherein the second region corresponds to a coverage area of the at least one satellite during the second time interval, and wherein the second region may comprise one of a country, a collection of countries, a portion of a country, a portion of oceans, and any combination thereof based on a coverage plan;
identifying a second set of user equipment in the second region to be provisioned the 5G communication network by the at least one satellite; and
retrieving a second set of user data profiles corresponding to the second set of user equipment from the centralized communication server.

3. The method of claim 2, further comprising:
provisioning the second set of user data profiles from the centralized communication server to the at least one satellite via the first gateway before the at least one satellite reaches the second region, thereby enabling the at least one satellite to provision the 5G communication network to the second set of user equipment based on the second set of user data profiles.

4. The method of claim 2, further comprising:
determining whether communication between the first gateway and the at least one satellite is terminated;
determining at least a second gateway of a plurality of gateways that is in communication with the at least one satellite when the communication between the first gateway and the at least one satellite is terminated; and
provisioning the second set of user data profiles from the centralized communication server to the at least one satellite via the second gateway before the at least one satellite reaches the second region, thereby enabling the at least one satellite to provision the 5G communication network to the second set of user equipment based on the second set of user data profiles.

5. The method of claim 1, further comprising:
determining a set of gateways from the plurality of gateways coupled between the centralized communication server and the first gateway when the first gateway is coupled to the centralized communication server by way of the set of gateways.

6. The method of claim 5, wherein the provisioning of the first set of user data profiles from the centralized communication server to the at least one satellite via the first gateway comprises:
routing the first set of user data profiles from the centralized communication server to the first gateway via the set of gateways.

7. The method of claim 1, wherein each user data profile comprises at least one of subscription data and policy data associated with a corresponding user equipment and indicates a type of service to be provisioned to the corresponding user equipment.

8. The method of claim 1, wherein the first set of user data profiles is provisioned to the at least one satellite via a routing plane of the centralized communication server and a routing plane of the first gateway.

9. The method of claim 1, wherein each satellite of the constellation of satellites is configured to implement a 5G core network, and a 5G base station that communicates with at least one user equipment of the plurality of user equipment.

10. The method of claim 9, wherein each gateway is configured to: route and forward the communications between the centralized communication server and the 5G core network of each satellite to facilitate the communications between the 5G base stations with the plurality of user equipment.

11. The method of claim 1, wherein the first region corresponds to a coverage area of the at least one satellite during the first time interval, and wherein the first region may comprise one of a country, a collection of countries, a portion of a country, a portion of oceans, and any combination thereof based on a coverage plan.

12. The method of claim 1, further comprising:
utilizing the first set of user data profiles for at least one of registration management, authentication, authorization, session management, charging, billing, service access, and mobility management associated with the 5G communication network for the first set of user equipment.

13. The method of claim 1, further comprising:
storing a first set of user information associated with the first set of user data profiles in the centralized communication server by a previous satellite of the constellation of satellites as the previous satellite provisions the 5G communication network to the first set of user equipment during a previous time interval; and
provisioning the first set of user information from the centralized communication server to the at least one satellite via the at least one gateway before the at least one satellite reaches the first region.

14. The method of claim 13, wherein each user information of the first set of user information comprises:
authentication information associated with the user equipment;
registration information generated at completion of registration of a user equipment with the previous satellite;
session setup information generated during session establishment procedures between the user equipment and the previous satellite;
control context and user plane context required to continue a communication session of the user equipment on the 5G communication network provisioned by the previous satellite; and
charging data associated with the communication session.

15. The method of claim 1, further comprising;
generating a second set of user information associated with the first set of user data profiles as the at least one satellite provisions the 5G communication network to the first set of user equipment during the first time interval; and
provisioning the second set of user information from the at least one satellite to the centralized communication server via at least the first gateway.

16. The method of claim 15, further comprising:
provisioning the second set of user information from the at least one satellite to a next satellite via at least the first gateway and the centralized communication server before the next satellite reaches the first region, wherein the provisioning of the second set of user information from the at least one satellite to the next satellite ensures continuity in the communication session of the user equipment on the 5G communication network during handover of coverage from the at least one satellite to the next satellite.

17. The method of claim 1, wherein the 5G communication network corresponds to a low earth orbit (LEO) satellite based 5G communication network.

18. A system for provisioning data in a fifth generation (5G) communication network, comprising:
at least one hardware-based processor and memory, wherein the memory comprises processor-executable instructions encoded on a non-transient processor-readable media, wherein the processor-executable instructions, when executed by the processor, configure the system to:
store a plurality of user data profiles associated with the 5G communication network in a centralized communication server;
determine at least one satellite of a constellation of satellites that provisions 5G communication network over a first region on the Earth during a first time interval;
identify a first set of user equipment in the first region to be provisioned the 5G communication network by the at least one satellite;
retrieve a first set of user data profiles corresponding to the first set of user equipment from the centralized communication server;
determine at least a first gateway of a plurality of gateways that is in communication with the at least one satellite, wherein each gateway is communicatively coupled with the centralized communication server; and
provision the first set of user data profiles from the centralized communication server to the at least one satellite via the first gateway before the at least one satellite reaches the first region, thereby enabling the at least one satellite to provision the 5G communication network to the first set of user equipment based on the first set of user data profiles.

19. The system of claim 18, wherein the processor-executable instructions, when executed by the processor, further configure the system to:
determine a movement of the at least one satellite such that the at least one satellite provisions 5G communication network over a second region on the Earth during a second time interval, wherein the second region corresponds to a coverage area of the at least one satellite during the second time interval, and wherein the second region may comprise one of a country, a collection of countries, a portion of a country, a portion of oceans, and any combination thereof based on a coverage plan;
identify a second set of user equipment in the second region to be provisioned the 5G communication network by the at least one satellite;
retrieve a second set of user data profiles corresponding to the second set of user equipment from the centralized communication server; and
provision the second set of user data profiles from the centralized communication server to the at least one satellite via the first gateway before the at least one satellite reaches the second region, thereby enabling the at least one satellite to provision the 5G communication network to the second set of user equipment based on the second set of user data profiles.

20. A non-transitory computer-readable medium storing a set of instructions for provisioning data in a fifth generation (5G) communication network, the set of instructions comprising:
one or more instructions that, when executed by one or more processors of a device, cause the device to:
store a plurality of user data profiles associated with the 5G communication network in a centralized communication server;
determine at least one satellite of a constellation of satellites that provisions 5G communication network over a first region on the Earth during a first time interval;
identify a first set of user equipment in the first region to be provisioned the 5G communication network by the at least one satellite;
retrieve a first set of user data profiles corresponding to the first set of user equipment from the centralized communication server;
determine at least a first gateway of a plurality of gateways that is in communication with the at least one satellite, wherein each gateway is communicatively coupled with the centralized communication server; and
provision the first set of user data profiles from the centralized communication server to the at least one satellite via the first gateway before the at least one satellite reaches the first region, thereby enabling the at least one satellite to provision the 5G communication network to the first set of user equipment based on the first set of user data profiles.
